(19) United States
(12) Patent Application Publication
(10) Pub. No.: US 2026/0247161 A1
(43) Pub. Date: Aug. 20, 2026

(54) Methods and Apparatus for Providing Recommendations on AP and/or Extender Placement Along With How Many Extenders to Use

(71) Applicant: Charter Communications Operating, LLC, St. Louis, MO (US)

(72) Inventors: Daniela Capoj, Englewood, CO (US); Taren G. McCullough, Plymouth, MN (US)

(21) Appl. No.: 19/055,406

(22) Filed: Feb. 17, 2025

(51) Int. Cl. H04W 16/18; H04B 17/318; H04W 16/26; H04W 64/00

(52) U.S. Cl. CPC H04W 16/18; H04B 17/318; H04W 16/26; H04W 64/00

(57) ABSTRACT

Methods and apparatus for facilitating access point (AP) and/or extender placement and/or determining the number of extenders to use at a customer premises based on actual signal measurements are described. The methods and apparatus can provide the information and/or recommendations in an automated manner without requiring involvement of a network technician to perform on site measurements. In addition, deployment of wireless extenders can be facilitated by automated shipment of recommended extenders to the customer site for customer installation in cases where wireless extenders are recommended, and the customer accepts the recommendation. In some embodiments, the customer is provided, by the customer support server, with an option to select between two alternative experiences for collecting data: i) a guided approach or ii) an unguided approach. The customer received a device placement and/or recommendation on a number of extenders to add and is provided an opportunity to have the extenders automatically shipped.

### FIELD

The present application relates to methods and apparatus for facilitating access point (AP) and/or extender placement and/or determining the number of extenders to use at a customer premises.

### BACKGROUND

Today, there is not an intelligent assistant that suggests customers the best placement of the Access Point (AP), router or extender. Although there are professional site surveys, those are expensive and not cost effective for residential/Small and Medium Business (SMB) customers. Additionally, there are recommendations that are solely based on minimal customer input on residence square footage, floors, etc. Customers can place the AP anywhere in their residence, without knowing if that placement is the optimal one to get the best Internet speeds they are paying for. The absence of this data/information results in more customer calls. Customers that feel their coverage is inadequate can purchase an extender, but typically this decision is not based on data/information but on experience.

Professional surveys are used today to identify coverage areas in a home and recommend Extender count and placement. However, this approach typically requires an RF technician to visit the home site and perform measurements, which can be inconvenient and/or costly.

Drawing 100 of FIG. 1 illustrates one current approach to address the issue of inadequate WiFi coverage at a home site. In step 102, consider that customer 101, with WiFi end user communications device 103, is facing an issue with the WiFi coverage area at his home, as evident by an unacceptable level of quality of service or no available communications service, at various locations within his home. In step 104 customer 101 decides to get a WiFi extender. In step 106, the customer 101 visits the website of an extender supplier and tries to find out which one of a plurality of available alternative extenders is the right one for his home and how many he will need. In step 108, based on the number of rooms, square footage, preferred speed/number of Ethernet ports/bands, the website is going to suggest one of their products. In step 110 the customer buys the suggested extender, and without having any data, will place the extender at a location, which he thinks is the best location.

Thus, after initial installation, e.g., of a router with a WiFi access point (AP) or a WiFi AP, if the customer is having issues with the Internet speed, the customer typically has to call customer service to verify if the issue is because of the placement of the AP. Although there are professional site surveys, which can be performed, a professional site survey is expensive and not cost effective for a residential customer. The customer is typically blind to the data/information that would provide an accurate recommendation on the number of extenders and/or placement of purchased extender(s), causing: i) non-optimal number of extenders causing performance issues; and ii) non-optimal extender placement causing performance issues.

In view of the above, it should be appreciated that there is a need for providing a customer options for improving the wireless performance at customer site preferably based on actual performance measurements and without the need for a technician to visit the customer premise site. While not necessary for all embodiments it would be desirable if in at least some embodiments an automated process could be developed to provide a customer a measurement based recommendation for AP placement and/or a recommendation with regard to wireless extenders, e.g., a recommended number to deploy and/or suggestions to where they should be placed.

### SUMMARY

Methods and apparatus for facilitating access point (AP) and/or extender placement and/or determining the number of extenders to use at a customer premises based on actual signal measurements are described. The methods and apparatus can provide the information and/or recommendations in an automated manner without requiring involvement of a network technician to perform on site measurements. In addition, deployment of wireless extenders can be facilitated by automated shipment of recommended extenders to the customer site for customer installation in cases where wireless extenders are recommended, and the customer accepts the recommendation.

In some embodiments, a customer will receive a text message or a notification, e.g., on or via a mobile app (also sometimes referred to as a mobile device application), that their AP has a potential to give better speed rates if placed in another location in the house and/or if wireless extenders are deployed. The message or notification redirects the customer to a new page, e.g., a web page provided by a customer support server, that will have instructions on how to collect the data that is needed for the site evaluation and recommendations.

In some embodiments, the customer is provided, by the customer support server, with an option to select between two alternative experiences for collecting data: i) a guided approach or ii) an unguided approach. In the guided approach, the customer will be guided to walk throughout the home site, e.g. the customer will be guided to walk around the perimeter of each room of the house, and the app will track key metrics including, for example, a received signal strength indicator (RSSI) and the location corresponding to the measured RSSI. Multiple RSSIs and corresponding location information are collected by the UE device and reported to the customer support server. During the data collection process, in some embodiments, there will be pop-up messages, and input from the customer, which is used to increase the accuracy of the data and/or provide customer premises site details.

In the unguided approach to collecting data, the customer is allowed to use the user device in a normal manner and the app on the user's mobile device collects key metrics, e.g., RSSI measurements and corresponding location information, in the background, as the customer goes about his or her day.

The collected RSSI and corresponding location information collected by the user device, whether it is collected as part of a guided or unguided site survey, is communicated back to the customer support server. The customer support server analyzes the collected RSSI and location information and generates a signal strength map of the customer premises being surveyed. The collected information is also used by the customer support server to generate a recommendation with regard to a number of wireless extenders which should be deployed at the surveyed customer premises and/or recommendations for placement of the wireless AP and/or recommended extenders at the customer premise.

The customer is provided from the customer support server, via the customers mobile device, following information collection and analysis: i) a heat map of the house and/or ii) statistics on how the ecosystem is performing. Given the collected data, the app will recommend, based on the server determinations, one or more or all of: i) an optimal placement (new placement) of the router including AP or the AP, ii) a recommended count of the suggested number of extenders that would improve the WiFi experience, iii) information identifying the type/model of each recommended extenders to be added, and/or iv) optimal placements for each of the recommended extenders.

In some embodiments, if the customer agrees to the recommendation the customer support server will automatically ship the recommended extenders with installation instructions including in some embodiments a printed floor plan of the customer's premises with the suggested locations where the AP and/or extenders to be placed being shown on the printed documents provided with the extenders. In other embodiments the extenders are automatically shipped, and the installation instructions/floorplan are provided to the customer via the mobile application on the customer's mobile device (UE).

The methods and apparatus allow a detailed signal based survey to be conducted and extenders deployed in an automated manner without the need or requirement for a technician to visit the customers site where the WiFi AP and/or extenders are installed.

While various features have been described in the summary, not all features are required for all embodiments and thus some embodiments may include or support less than the full set of exemplary features discussed above.

Numerous variations and examples of the methods and apparatus of the present invention are discussed in the detailed description which follows.

### BRIEF DESCRIPTION OF THE FIGURES

FIG. 1 shows a known prior art approach to addressing the issue of inadequate WiFi coverage at a home site.

FIG. 2 illustrates a system 200 implemented in accordance with one embodiment of the present invention.

FIG. 3A is a drawing showing a first part of flow chart showing the steps involved in one exemplary method of the present invention.

FIG. 3B is a drawing showing a second part of flow chart showing the steps involved in one exemplary method of the present invention.

FIG. 3C is a drawing showing a third part of flow chart showing the steps involved in one exemplary method of the present invention.

FIG. 3 is a drawing showing how FIGS. 3A, 3B and 3C can be combined to form a complete flow chart.

FIG. 4A is a drawing showing a first part of an unguided site survey routine implemented in accordance with one embodiment of the present invention and which can be called by a step in the flow chart of FIG. 3.

FIG. 4B is a drawing showing a second part of an unguided site survey routine implemented in accordance with one embodiment of the present invention and which can be called by a step in the flow chart of FIG. 3.

FIG. 4 is a drawing showing how FIGS. 4A and 4B can be combined to form a complete flow chart.

FIG. 5A is a drawing showing a first part of a guided site survey routine implemented in accordance with one embodiment of the present invention and which can be called by a step in the flow chart of FIG. 3.

FIG. 5B is a drawing showing a second part of a guided site survey routine implemented in accordance with one embodiment of the present invention and which can be called by a step in the flow chart of FIG. 3.

FIG. 5 is a drawing showing how FIGS. 5A and 5B can be combined to form a complete flow chart.

FIG. 6A is a first part of a flowchart of an exemplary placement of an access point (AP) and/or extenders recommendation routine, in accordance with an exemplary embodiment.

FIG. 6B is a second part of a flowchart of an exemplary placement of an access point (AP) and/or extenders recommendation routine, in accordance with an exemplary embodiment.

FIG. 6 comprises the combination of FIG. 6A and FIG. 6B.

FIG. 7 is a flowchart of a number of extenders recommendation routine, in accordance with an exemplary embodiment.

FIG. 8 is drawing illustrating a guided approach to the collection of RSSI data at a customer home site to be analyzed to determine a recommended number of wireless extenders, recommended wireless extender placement locations, and/or recommended access point (AP) placement location.

FIG. 9 is drawing illustrating a unguided approach to the collection of RSSI data at a customer home site to be analyzed to determine a recommended number of wireless extenders, recommended wireless extender placement locations, and/or recommended access point (AP) placement location.

FIG. 10A illustrates a first exemplary sample distribution, corresponding to collected RSSI data at a customer home site, and corresponding recommendations as to the number of wireless extenders to be installed to improve wireless coverage.

FIG. 10B illustrates a second exemplary sample distribution, corresponding to collected RSSI data at a customer home site, and corresponding recommendations as to the number of wireless extenders to be installed to improve wireless coverage.

FIG. 10C illustrates a third exemplary sample distribution, corresponding to collected RSSI data at a customer home site, and corresponding recommendations as to the number of wireless extenders to be installed to improve wireless coverage.

FIG. 10 comprises the combination of FIG. 10A, FIG. 10B and FIG. 10C.

FIG. 11 is a drawing which illustrates an exemplary embodiment, in which an Internet Service Provider (ISP) recommends an extender placement to a customer based on: i) where in the customer home site layout the worst RSSI values were measured, and ii) the average measured RSSI in a room.

FIG. 12 is a drawing, which illustrates an exemplary embodiment, in which the ISP recommends an extender placement to a customer based on: i) where in the customer home site layout the worst RSSI values were measured, ii) the average measured RSSI in a room, and iii) customer priority information.

FIG. 13 is a drawing illustrating a visual representation of the extender benefit from the data driven AP/Extender Placement Assistance approach of the present invention, in accordance with an exemplary embodiment.

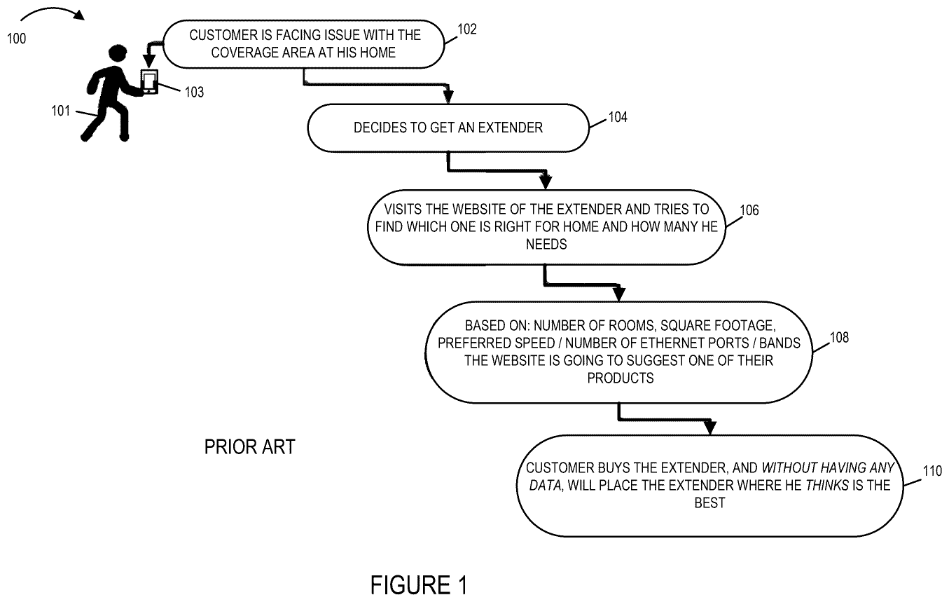

### DETAILED DESCRIPTION

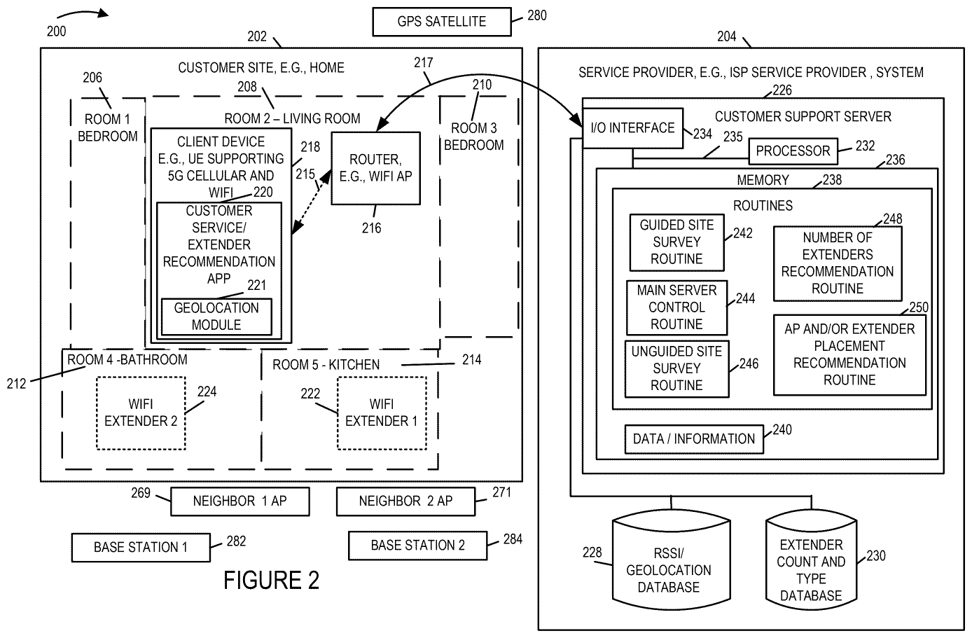

FIG. 2 illustrates a system 200 implemented in accordance with one embodiment of the present invention. The system 200 includes a customer premises site 202, e.g., a home or office, a service provider system 204, a first base station 282, a second base station 284 and a global positioning system (GPS) satellite 280. While one GPS satellite 280 is shown, it should be appreciated that there is a constellation of multiple such satellites 280 which transmit signals which can be received by a wireless device and used to determine the location of the receiving device. The first and second base stations 282, 284 are, in some embodiments, cellular base stations. A device receiving signals from the cellular base stations 282, 284 can determine its location from the signals received from these base stations given that the base station's 282, 284 have a known fixed location.

The customer premises site 202, e.g., a home or office, includes a plurality of rooms, e.g., five rooms 206, 208, 210, 212, 214. A first room 206 in the example is a bedroom. A second room 208 in the example is a living room. The living room 208 includes a client device, e.g., user equipment (UE) which supports 5G cellular communications with base stations 282, 284 and WiFi communications, represented by dashed line 215, with wireless router 216 which is also located in the second room 208. The wireless router 218 is, in some embodiments, a WiFi access point (AP) with connectivity to service provider system 204 as represented by arrow 217. The connection 217 to the service provider system 204 can be via a cable connection, fiber optic connection, wired connection or a wireless connection. The service provider system 204 provides Internet connectivity to the user device 218 with the user of the user device being a customer of the service provider which in the example is an Internet service provider (ISP). Accordingly, the user, e.g., human being using the UE 218, may be referred to as a user since they are the user of the UE device 218 and/or referred to as a customer since they are the customer of the service provider to which the service provider system 204 corresponds.

The service provider system 204 includes a customer support server 226 which can be contacted by a user of the UE 218 to receive support for such things as Internet access and/or with concerns over WiFi issues at the customer premises 202. The customer support server 226 includes an I/O interface 234 which supports communication with customer device 218. The I/O interface is coupled to a processor 232 and memory 236 which are also part of the customer support server 226 by bus 235. The I/O interface is also coupled to a Received Signal Strength Indicator (RSSI) and geolocation information database (228) as well as an extender count and extender type database 230 via connection 227. The RSSI/Geolocation database 228 includes RSSI measurements and information indicating where the individual RSSI measures were taken for one or more customer sites. In some embodiments the RSSI/geolocation database 228 is used to

The WiFi AP provides wireless coverage, e.g., WiFi coverage, and Internet access to devices such as the UE 218 located at the customer site 202 which can move around the customer site 202 as the user moves from room to room. In the exemplary embodiment the UE 218 includes a customer support application, e.g., a customer service and extender recommendation application 220, which is stored in the memory of the UE 218 and is executed by a processor in the UE 218. When executed by the processor of the UE the APP 220 can be used to contact and interact with the customer support server 226, report wireless problems, conduct RSSI measurements and determine the location of the UE 218 as it moves around the customer premises 208. In order to determine the location of the UE 218 as it moves around the customer premises, the customer service application includes a geolocation determination module 221 which can determine the location of the device 218 based on wireless signals received from GPS satellites 280, APs 269, 271 located at neighbor customer premises and/or based on cellular signals received from cellular base stations 282, 284.

The wireless router 216, shown in the FIG. 2 example, is a WiFi access point. In response to encountering unsatisfactory wireless coverage at one or more locations, e.g., rooms, of the customer premises based on service provided by the AP 216, the user of the UE 218 can contact the customer support server 226 and report the wireless coverage issues. As will be discussed further the customer support server 226 can control the UE, via interaction with the customer service application 220 to conduct a wireless site survey of the customer site 202 without the need for a technician to be sent to the site. The site survey can be an unguided site survey in which RSSI and corresponding location information is collected as the customer/user moves throughout the customer site 202 as part of performing normal unguided activities. Alternatively, the customer support server 226 may guide the user to perform a guided site survey in which the user walks around the perimeter of rooms and/or the customer premises 208 to generate a site survey with the UE 218 taking RSSI measurements and storing corresponding location information as the UE 218 moves around the customer premises. The RSSI and location information generated by the UE 218 as part collecting measurements as part of a survey of the site 202 are reported back to the customer support server 226 which processes the information and makes a recommendation with regard to AP placement, a number of extenders which are recommended for the site and the location where the extenders should be placed if extenders are recommended. The type or extenders to be used can also be indicated with different types of extenders being recommended for different conditions and/or depending on the need to support multiple extenders rather than a single extender at the site 202. The user of the UE, if agreeable to an extender recommendation, can indicate agreement and have the customer support system 226 automatically ship the recommended extenders to the customer site 202 for installation by the user, e.g., at the recommended locations. In the FIG. 2 example, the WiFi AP 216 is initially deployed but following a customer site survey and recommendation by customer support server 226, two WiFi extenders 222, 224 are added to the customer site 202 with these extenders being shown with dashed lines to indicate that they are added at a later time to the time at which the router 216 was originally deployed.

The customer support survey 226 includes a memory 236 which includes data/information 240 and a plurality of routines 238 which, when executed by the processor 232, control the customer support server 226 to operate in accordance with the invention. The routines 238 can be, and sometimes are, executed by the processor 232. In other embodiments, rather than use software routines, hardware modules, that implemented fully in hardware are included in the server 226, and are used to control the customer support server 226 to implement the operations that are performed by the routines 238. The routines 238 include a main server control routine 244, a guided site survey routine 242, an unguided site survey routine 246, a number of extenders recommendation routine 248, and an AP and/or extender recommendation routine 250.

The main server control routine 244 controls the service provider system 236 to operate in accordance with the invention to provide customer service support and is responsible for calling one or more of the other routines as needed to perform various functions relating to a site survey, recommendation with regard to a number of extenders to be used at a site, the type of extenders to be used and/or to determine a recommended placement of an AP and/or recommended extenders.

The guided site survey routine 242 controls the customer support server 226 to interact with the UE 218 when a guided site survey is to be performed and generates a site survey, e.g., heat map showing wireless signal strength, at the site when such a survey is performed.

The unguided site survey routine 244 controls the customer support server 226 to interact with the UE 218 when an unguided site survey is to be performed and generates a site survey, e.g., heat map showing wireless signal strength at the site, when such a survey is performed. The unguided site survey can be and sometimes is collected based on RSSI and location information as a user moves around the site 202 in an unguided manner as part of his/her normal operations or movement over a period of time.

The number of extenders recommendation routine 248 is used to determine, based on RSSI and/or location information collected by the UE 218, a number of recommended wireless extenders. In various embodiments zero, one, or two extenders may be recommended depending on the collected RSSI information.

AP and/or extender placement recommendation routine 250 is used to provide an AP placement recommendation and/or a recommendation as to where extenders that have been recommended should be placed at the customer premises 202.

RSSI and corresponding location information for one or more customer premises that are supplied to the customer support server 226, e.g., from UEs, are stored in the RSSI/geolocation database 228. Information on the number of extenders and the type of extenders, which have been recommended for a customer premises 202, are stored in extender count and type database 230. While shown as being separate databases 228, 230 the information in these databases can be stored in a single database and/or in the data/information portion 240 of memory 236.

While the invention is explained in the context of a single exemplary customer site 202, it should be appreciated that customer support server 226 normally provides customer support for multiple customer premises sites and thus RSSI/geolocation database and extender count and type database will normally include multiple entries with information corresponding to different customer premises.

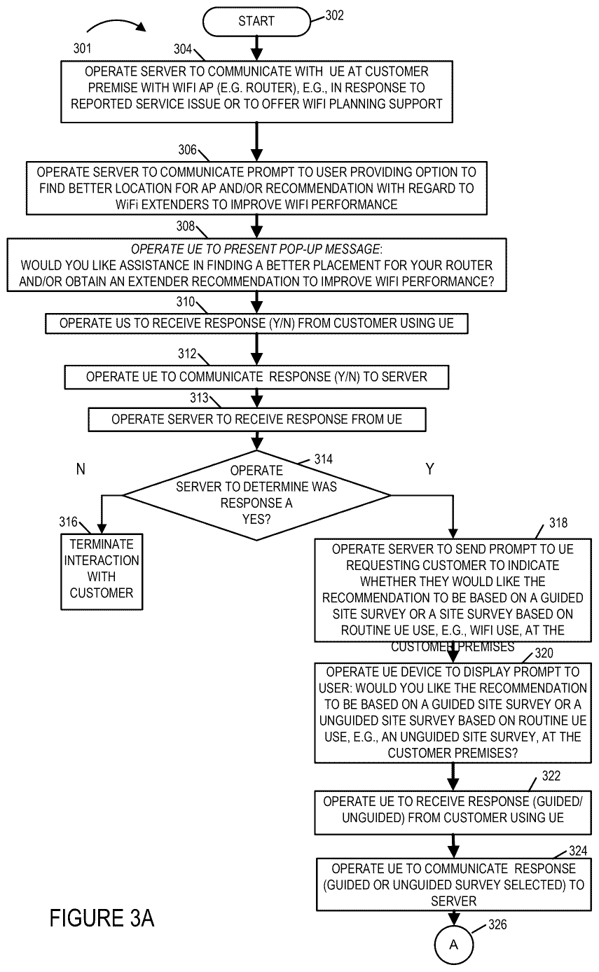

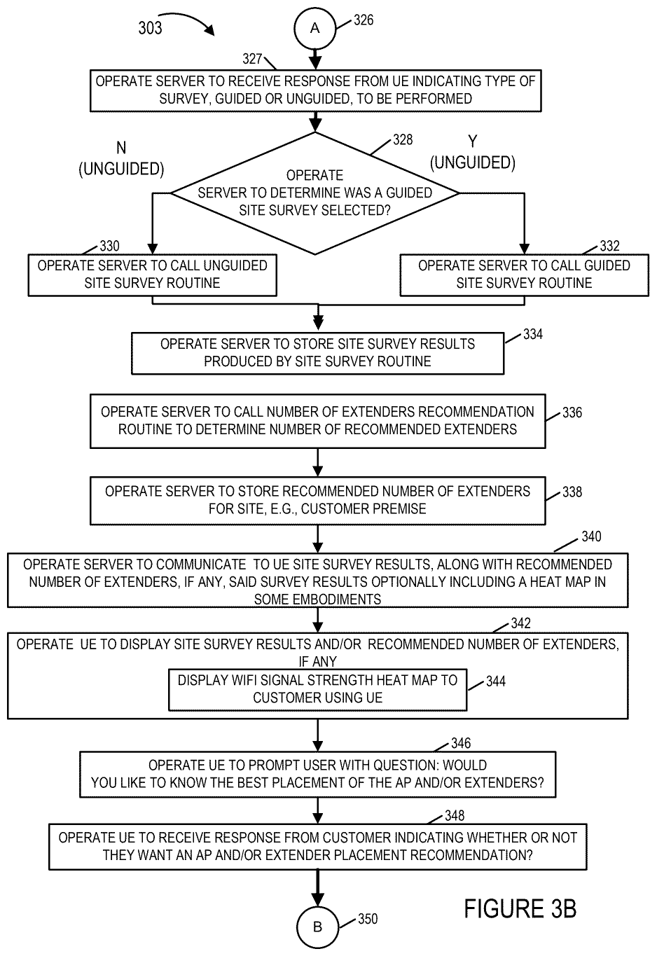

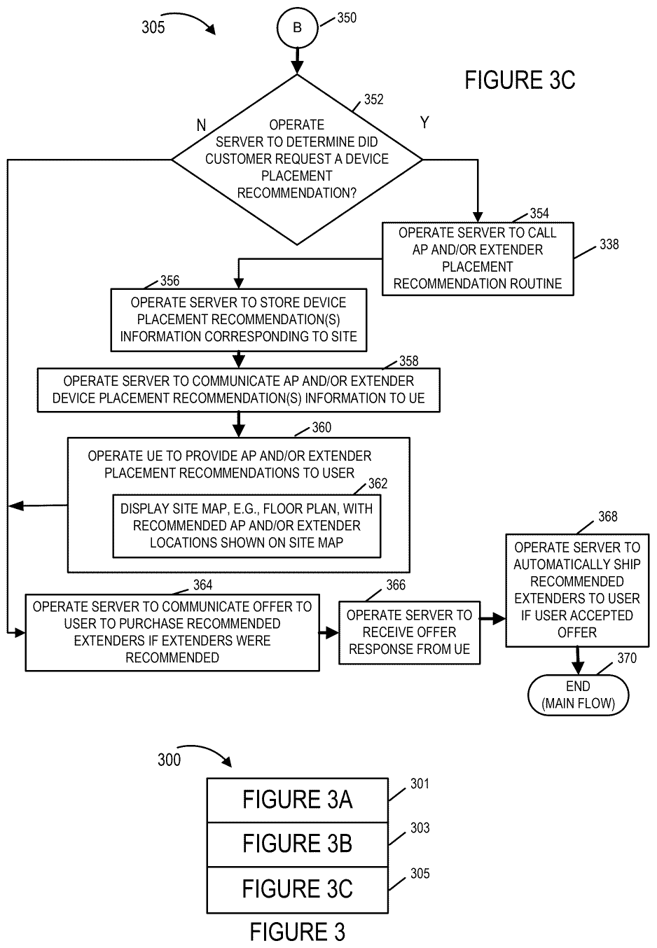

Having generally described the system 200, exemplary operation of the customer support server 226 and UE 218 will now be described with reference to FIG. 3. FIG. 3 is a diagram 300 showing how the diagrams 301, 303 and 305 of FIGS. 3A, 3B, 3C can be combined to form a complete flow chart showing the operation of the customer support server 226 interacting with the UE 218 to provide support for customer premise site 202.

The method shown in FIG. 3 will now be discussed. Steps in FIG. 3 performed in FIG. 3 by a server are steps performed by the customer support server 226, e.g., under control of the main server control routine 244, while steps performed by a UE are steps performed by exemplary UE 218, e.g., under control of the application 220. The method begins in start step 302 of FIG. 3A with the customer support server 226 being powered on and executing the main server control routine 244 which controls the server 226 to implement the steps shown in FIG. 3.

Operation proceeds from start step 302 to step 304 in which the server 226 communicates with the UE 218 at the customer premises site 202, e.g., via communications links 217, 215 with the communication being in response to a reported service issue signed by the APP 220 to the customer support server 226 or in response to the support server offering WiFi planning support, e.g., in response to the server 226 detecting low data rates for some communications from the UE 218 while at the customer premise site 202. With communication between the UE customer service application 220 and server 226 having been established, operation proceeds to step 306 in which the server 226 communicates a prompt to the UE 218 providing the user an option to find a better location for the AP 216 and/or obtain an extender recommendation to improve WiFi performance at the customer premises 202.

The UE 218 presents, in step 308, the server 226 provided prompt to the customer in the form of a message on the UE, e.g., a pop up message, e.g., with the prompt in some embodiments stating “Would you like assistance in finding a better placement for your wireless AP and/or an extender recommendation to improve WiFi performance?”.

In step 310 the UE 218 receives a response to the prompt with the user indicating Yes (Y) to receive assistance with respect to AP placement and/or an extender recommendation or No (N) if assistance is not desired. The UE received response from the user is communicated to the server 226 in step 312 and received by the server 226 in step 313. With the response to the assistance offer having been received by the server 226 in step 313, operation proceeds to step 314. In step 314 the server 226 determines if the response to the offer for assistance was a yes. If it is determined in step 314 that the user did not accept the assistance offer (an N response was determined) operation proceeds to step 316 in which the server 226 terminates the interaction with the customer. If in step 314 it is determined that the user accepted the offer of assistance (a Y response was received) operation proceeds from step 314 to step 318.

In step 318 the server 226 sends a prompt to the use 218 requesting that the customer indicate whether they would like the recommendation to be provided based on a guided site survey or an unguided site survey based on routine UE use, e.g., WiFi use at the customer premises site 202. Then in step 320 the UE device 218 displays a prompt to the user requesting information on whether the user wants to proceed with a guided or unguided survey of the site. In the exemplary embodiment the UE 218 displays the prompt “Would you like the recommendation to be based on a guided site survey or an unguided site survey based on routine UE use?”. In step 322 the UE receives a response indicating selection by the user of a guided site survey or unguided site survey and then in step 324 the UE communicates the user selection, e.g., guided or unguided, to the server 226. Operation proceeds from step 3245 to step 327 of FIG. 3B via connecting node 326.

In step 327 the server 226 receives the response from the UE 218 indicating the type of survey, guided or unguided, which was selected. Then, in step 328, the server 226 examines the response to determine whether a guided or unguided survey was selected.

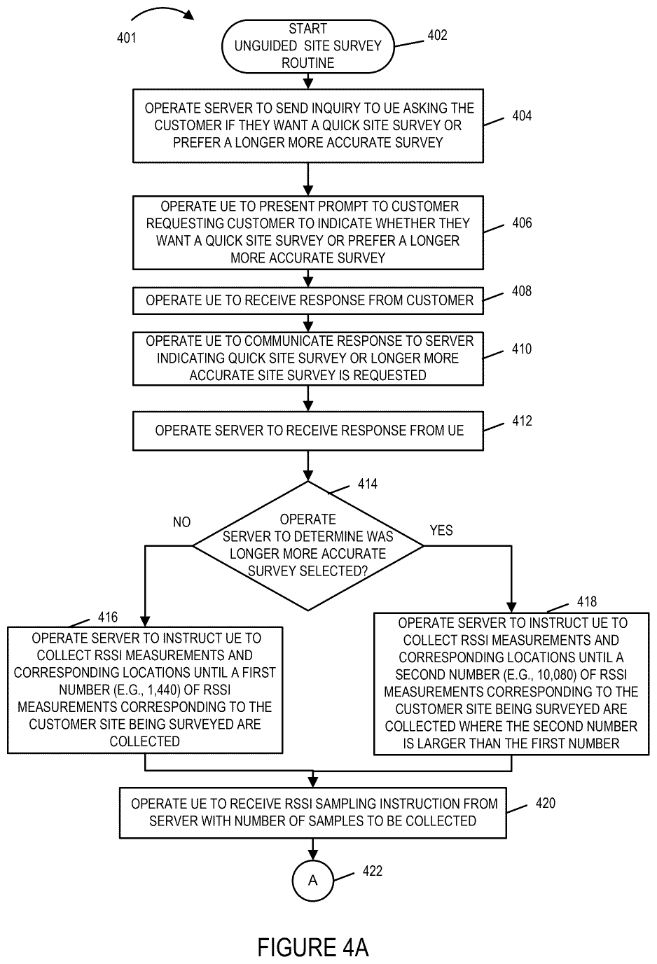

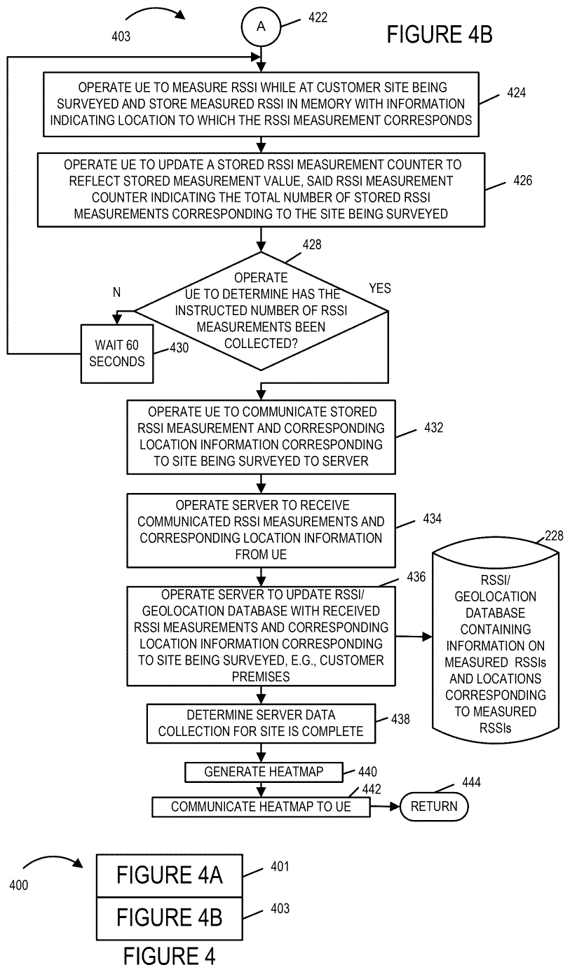

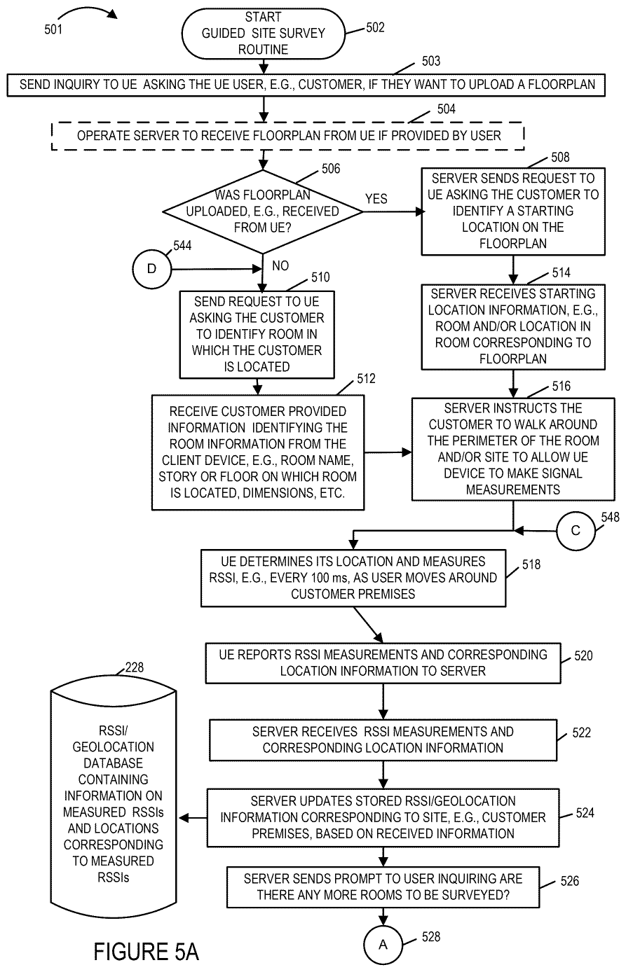

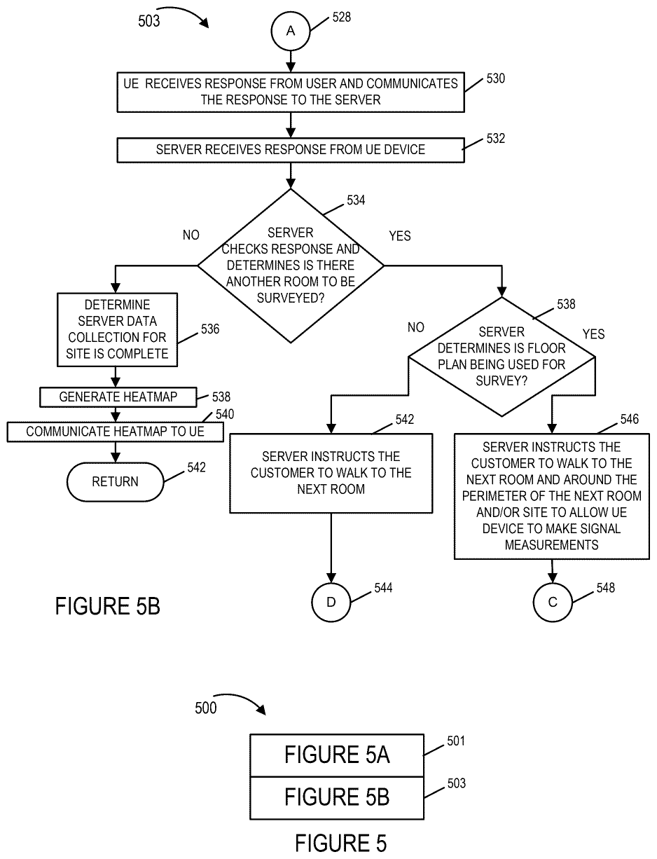

If in step 328 it is determined that an unguided survey was selected operation proceeds to step 330 and the unguided site survey routine (see FIG. 4) is called. However, if in step 328 it is determined that a guided survey was selected, operation proceeds to step 332 and the guided site survey routine (see FIG. 5) is called.

Site survey results, e.g., collected RSSI and location information and/or a wireless signal strength heat map, are generated as a result of the conducted survey whether it be a guided or unguided survey, and are returned from the call to the survey routine that is made. With the survey results having been returned, operation proceeds from step 330 or step 332 to step 334 in which the server 226 stores the results, e.g., RSSI measurements, RSSI measurement location information and/or a heatmap, e.g., in RSSI/geolocation database 228.

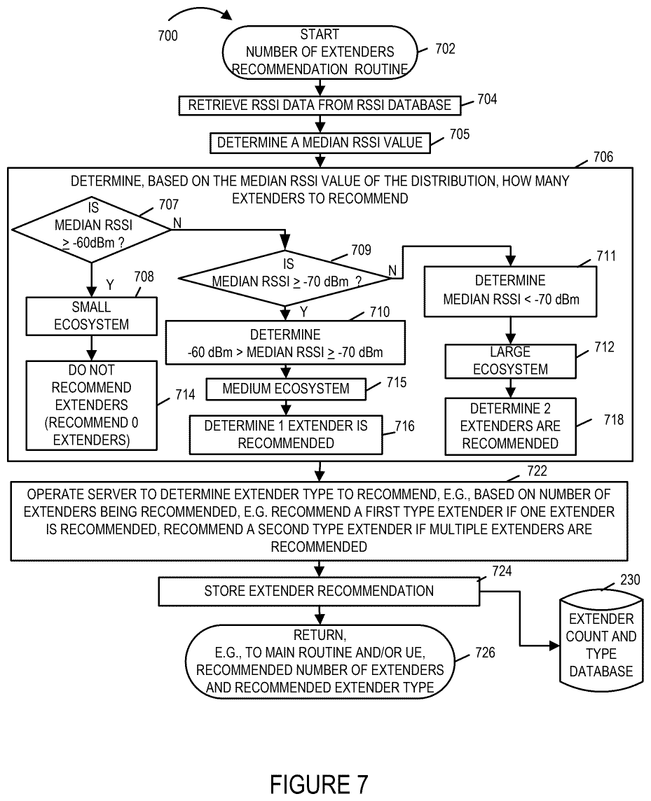

Operation proceeds from survey results storage step 334 to step 336 in which the server 226 makes a call to the number of extenders recommendation routine 248 (see FIG. 7). The number of extenders recommendation routine 248 generates and returns a recommended number of wireless, e.g., WiFi, extenders and in some cases as to the type (e.g., model and/or brand) of extender being recommended. The recommendation in some embodiments is for zero extenders, 1 extender or 2 extenders.

In step 338 the server 226 stores, e.g., in extended count database 230, the recommended number of extenders along with extender type information when that is available. Thus as recommendations are generated for a customer premise they will be stored in extender count database 230 with the database 230 eventually including recommendations for multiple different customer premises served by the server 226.

Operation proceeds from storage step 338 to step 340 in which the server 226 communicates the site survey results along with the recommended number of extenders with, in some embodiments the survey results including a wireless signal strength heat map showing WiFi signal strength at various locations at the customer site through the use of signal shading to represent different signal strength levels.

In step 342, under control of application 320, the UE displays the site survey results, e.g., the signal strength heat map or some other set of signal strength information along with the recommended number of extenders if extenders are being recommended. In some embodiments step 342 includes sub-step 344 in which the UE 226 displays the WiFi signal strength heat map corresponding to the surveyed site to the user of the UE 218.

With the user having been presented the results of the site survey and the extender recommendation, operation proceeds to step 346 in which the UE prompts the user to determine if the user wants an AP and/or extender placement recommendation. In some embodiments step 346 includes asking the user “Would you like to know the best placement of the AP and/or extenders?”. Operation proceeds from prompt step 346 to step 348 wherein the UE receives a response from the user indicating whether the user would like an AP and/or extender placement recommendation.

Operation proceeds from step 348 via connecting node B 350 to step 352 shown in FIG. 3C. In step 352 the server determines, e.g., from the response communicated from the UE to the server, whether the customer requested a device placement recommendation. If it is determined that the customer did not request a device placement recommendation (N decision in step 352) operation proceeds to step 364.

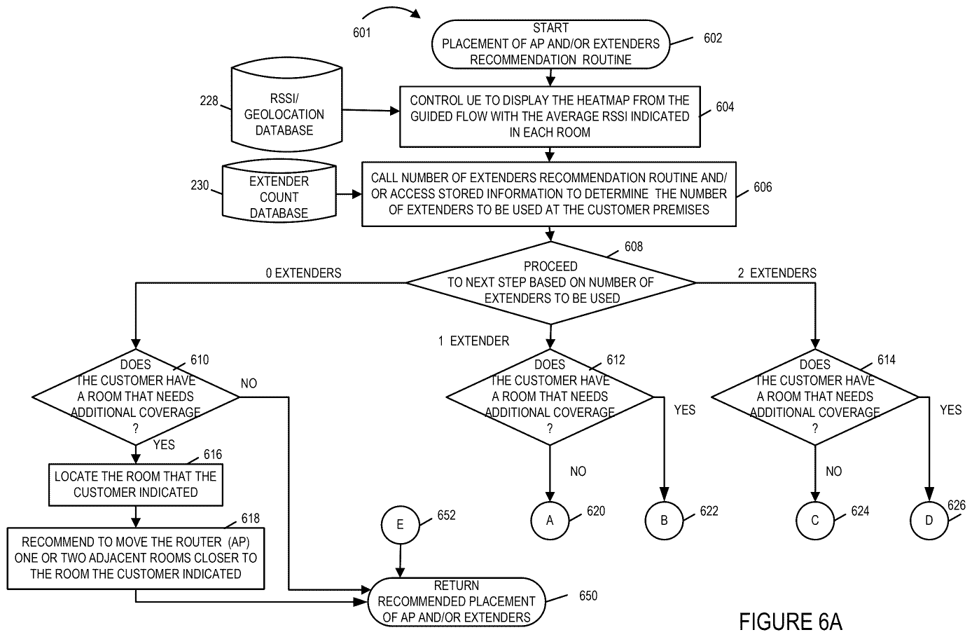

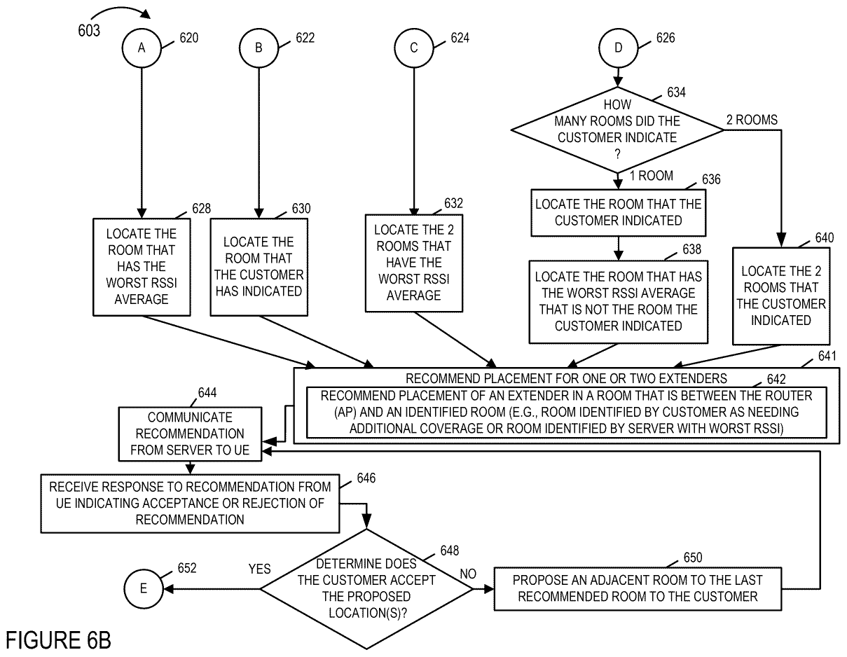

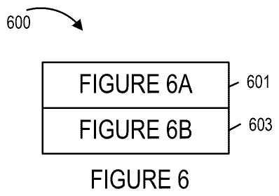

In step 352 if it is determined that the customer requested a device placement recommendation operation proceeds to step 354. In step 354 the server 226 calls the AP and/or extender placement recommendation route 250 (see FIG. 6) which returns device placement recommendations, e.g., where the AP 206 and/or recommended extender(s) 222, 224 should be positioned at the customer premises site 212.

Operation proceeds from step 354 to step 356 in which the server stores the device placement recommendations, e.g., in data/information 240 in memory, before communicating the placement recommendation(s) to the UE 218 in step 358.

With the device placement recommendations having been received by the UE 218m the UE 218 proceeds, in step 360, to present the device placement recommendations to the user. In some embodiments step 360 includes step 362 in which the UE 218 displays a site map, e.g., floorplan, of the customer premises 202 with the recommended AP and/or extender positions shown on the site map. Operation proceeds from step 360 to step 364.

In step 364 the server is operated to communicate an offer to the user to purchase the recommended extenders in the case where extenders were recommended. Assuming an offer was made to the user, in step 366 the server 226 receives a response to the offer in step 366. If the user accepted the offer to purchase the recommended extenders, in step 368 the server automatically ships the extenders to the customer so that the user can install them at the customer premises site 202 to improve WiFi signal coverage. With the customer having been provided a recommendation and/or opportunity to order WiFi extenders, operation process to end step 370 where interaction with the user ceases until they contact the customer support server 226 again.

The steps of the unguided site survey routine 400 shown in FIG. 4 will now be discussed. The routine 400 can be, and sometimes is, called from step 330 of the flow chart of FIG. 3. The survey routine 400 includes the steps of FIGS. 4A and 4B with FIG. 4 showing how the drawing 401 of FIG. 4A and be combined with the drawing 403 of FIG. 4B to form the complete flow chart 400. The unguided site survey routine 246, when executed by the server's processor 232 in response to a call from step 330 causes the server to perform the server operations listed in the flow chart 400.

The unguided site survey routine 400 begins in step 402 when the routine 246 is called, e.g., from step 330. Operation proceeds from start step 402 to step 404 in which the server 226 sends an inquiry to the UE 218 asking the customer if they want a quick site survey or prefer a longer more accurate survey. The answer to this question will control the number of RSSI measurements made and/or the duration of the unguided site survey.

In step 406 the UE 218, in response to the query from the server 226, presents a prompt to the customer requesting the customer to indicate whether they want a quick site survey or prefer a longer more accurate survey. Then in step 408 the UE 218 receives a response from the customer. The UE 218 communicates the received response to the server in step 410 with the response indicating whether the user selected a quick site survey or a longer more accurate site survey. Then, in step 412 the server 226 receives the response from the UE and in step 414 determines from the response whether the user selected the longer more accurate survey (Yes path) or the less accurate quick survey (No path from step 414).

If the quick survey was selected, operation proceeds from step 414 to step 416 in which the server 226 instructs the UE 218 to collect a first number, e.g., 1,440, of RSSI measurements and corresponding location information while the UE 218 is at the customer premises 202 to be surveyed. These measurements will be performed by the UE 218 as background operations as the user moves the UE 218 around the customer premises 202 during normal use of the UE device.

However, if in step 414 it is determined that a more accurate survey was selected, operation will proceed from step 414 to step 418 in which the server 226 instructs the UE 218 to collect a second number, e.g., 10,080, of RSSI measurements and corresponding location information while the UE 218 is at the customer premises 202 to be surveyed. These measurements will be performed by the UE 218 as background operations as the user moves the UE 218 around the customer premises 202 during normal use of the UE device. Sense the second number of measurements is much larger than the first number, the more accurate survey will take longer to complete than the quick survey but is likely to include more accurate results due to the much larger number of signal measurements as well as the fact that the measurements are likely to correspond to a larger number of locations given the increased number of samples taken at various points in time as the user moves about the customer premises as part of the user's normal routine.

Operation proceeds from steps 416 or 418, depending on which one is performed, to step 420 in which the UE receives the RSSI sampling instructions from the server 226 indicating the number of RSSI samples (e.g., measurements) to be collected as part of the unguided site survey being performed. Operation proceeds from step 420 via connecting node A 422 to step 424 of FIG. 4B.

In step 424 the UE measures received signal to obtain an RSSI value while at the site 202 being surveyed. The measured RSSI value is then stored in the UE memory as part of step 424 with corresponding location information indicating the location where the RSSI value was measured. This results in an RSSI value and location being stored as an entry in memory. Then in step 426 an RSSI measurement counter used to track the number of RSSI measurements completed as part of the survey is updated to reflect the most recent measurement. Operation proceeds from step 426 to step 428 where the value of the measurement counter is compared to the number of RSSI measurements to be collected, e.g., the first number or the second number depending on whether a quick or detailed survey is being performed. If the total number of measurements to be collected has not been reached operation proceeds from step 428 to step 430. In step 430 the UE 218 waits 60 seconds before proceeding to step 424 to take another RSSI measurement as part of the survey process.

If in step 428 it is determined that the total number of RSSI measurements to be collected has been reached as indicated by the RSSI measurement counter reaching the target number of measurements, operation proceeds to step 432. In step 432 the UE communicates the collected and stored RSSI measurements and corresponding location information to the server 226.

Then in step 434 the server 226 receives the communicated RSSI measurements and corresponding location information and process to step 436 in which the server 226 updates the RSSI/geolocation information database 228 with the received information corresponding to the customer premises 202 being surveyed thereby making it available for analysis and use by the server 226.

With the RSSI and location information having been stored and made available for further analysis, operation proceeds to step 438 in which the server 226 determines that data collection, at least in terms of RSSI measurements, is complete for the customer site 202 being surveyed. In step 440 a heatmap and/or other representation of the site survey results showing received signal strength at various locations at the customer premises 202 is generated and then in step 442 communicated to the UE for display to a user of the UE 218. With the unguided survey having been completed operation returns in step 444 to the point from which the unguided site survey was called.

The steps involved in a guided site survey under the direction of the guided site server routine 242 will now be discussed with reference to FIG. 5.

FIG. 5 is a flow chart 500 showing how the diagram 501 of FIG. 5A and the diagram 503 of FIG. 5B can be combined to form a complete flow chart corresponding to the guided site server routine 242.

The method shown in FIG. 5 begins in step 502 shown in FIG. 5A when the guided site survey routine 242 is called from step 332 shown in FIG. 3B and the routine is executed by the processor 232.

Operation proceeds from step 502 to step 503 in which the server 226 sends an inquiry asking the user, e.g., customer, if they want to upload a floorplan. In step 506 a check is made if a floorplan was uploaded, e.g., communicated from the UE 218 and received in step 504 by the server 226. If in step 506 it is determined that a floorplan was not uploaded operation proceeds to step 510. In step 510 the server 226 sends a request to the UE 218 asking the customer to identify the room in which the customer is located with the UE 218 so that the information can be used as s survey starting location. Operation proceeds from step 510 to step 512. In step 512 customer provided information identifying the room is received from the UE 218. In some embodiments the information received in step 512 includes a room name, story or floor on which the room is located and/or other information about the room such as room dimensions. Operation proceeds from step 512 to step 516.

If a floorplan was uploaded and received in step 504 operation will proceed from step 506 to step 508. In step 508 the server 226 sends a request to the UE 218 asking the customer to identify a starting location on the floor plan, e.g., room and/or location in a room included in the received floor plan. Operation proceeds from step 508 to step 514, in which the server 226 receives starting location information from the UE 218, e.g., information indicating a room and/or location in a room on the floor plan at which the UE 218 is located and the survey will start. Operation then proceeds from step 514 to step 516.

With the survey starting location information having been received in step 512 or 514 the server knows where the survey will start and in step 516 instructs, by sending an instruction to the UE 218, the customer to walk around the perimeter of the room and/or site 202 to allow the UE device 218 to make signal measurements at different locations as part of the survey.

Operation proceeds from step 516 to step 518. In step 518 the UE determines its location and measures RSSI, e.g., every 100 milli seconds, as the user moves around the customer premises 202 with the UE 218. In step 520 the UE reports to the server 226 RSSI measurements and corresponding location information, e.g., with different RSSI measurements corresponding to different locations due to the UE movement.

The in step 522 the server 226 receives the reported RSSI measurements and corresponding location information. The server 226 in step 524 updates stored RSSI and corresponding geolocation information corresponding to the site 202 by storing the received RSSI measurement information and corresponding location information in RSSI/Geolocation database 228 with the information being associated with customer premises site 202 in the database 228.

Operation proceeds from information storage step 524 to step 526 in which the server 226 sends a prompt to the UE 218 inquiring from the user if there are any more rooms to be surveyed.

Operation proceeds from step 526 to step 530 of FIG. 5B via connecting node A 528. In step 530 the UE 218 receives a response, from the user, to the inquiry made by the server 226 indicating whether or not there are any more rooms to be surveyed.

In step 532 the server 226 receives the response information from the UE and then in step 534 checks the response to determine if there is another room (e.g., at least one more room) to be surveyed. If in step 534 it is determined that there are no more rooms to be surveyed operation proceeds to step 536. However, if in step 536 it is determined that there are more rooms to be surveyed operation proceeds to step 538.

In step 538 a check is made whether the user provided a floor plan or not to determine how to proceed. If in step 538 it is determined that a floor plan was provided and is being used for the survey, operation proceeds to step 546. In step 546 the server instructs the customer to walk to the next room and to proceed around the perimeter of the next room(s) and/or site to allow the UE device to make signal measurements. Operation proceeds from step 546 via connecting node C 548 to step 518 of FIG. 5A.

If in step 538 it is determined that the server is not using a floor plan in making the survey, operation proceeds to step 542 in which the server instructs the customer to walk to the next room. Operation proceeds from step 542 to step 510 via connecting node D 544 so that the customer can identify the room to be surveyed, and the survey can continue.

If in step 534 it was determined that there were no other rooms to be surveyed, operation proceeds from step 534 to step 536 in which the server 226 determines that data collection for the site survey has been completed.

Operation proceeds from step 536 to step 538 in which the server generates a heat map and/or other site survey results from the collected data. The site survey results generated in step 538 are communicated to the UE in step 540 before operation returns in step 542 to the point from which the guided site survey routine 242 was called.

FIG. 6, comprising the combination of FIG. 6A and FIG. 6B, is a flowchart 600 of an exemplary placement of an access point (AP) and/or extenders recommendation routine, in accordance with an exemplary embodiment. Operation starts in step 602 and proceeds to step 604. In step 604 the server, e.g., customer supports server 226, control UE 218 to display the heatmap from the guided flow with the average RSSI indicated in each room. In some embodiments, step 604 includes the server 226 retrieving a stored previously generated heatmap, e.g., from RSSI/geolocation database 228, or generated a heatmap from information in RSSI/geolocation database 228, and sending the heatmap to UE 218 with instructions for the UE 218 to display the heatmap on its display to the customer. Operation proceeds from step 604 to step 606.

In step 606, server 226 calls number of extenders recommendation routine 700 and/or accesses stored information in extender count database 230, to determine the number of extenders to be used at the customer premises. Operation proceeds from step 606 to step 608. In step 608 the server 226 proceeds to the next step based on the number of extenders to be used. If the number of extenders to be used at the customer premises is 0, then operation proceeds from step 608 to step 610. Alternatively, if the number of extenders to be used at the customer premises is 1, then operation proceeds from step 608 to step 612. Alternatively, if the number of extenders to be used at the customer premises is 2, then operation proceeds from step 608 to step 614.

In step 610, the server 226 determines if the customer has a room that needs additional coverage. In some embodiments, step 610 includes the server 226 sending an inquiry message, e.g., a pop-up message, to UE 218, to be presented to the customer requesting if the customer has a room that needs additional coverage and asking for information to identify or locate the room, and receiving a customer response from UE 218, and extracting the information from the customer response, e.g., yes with room information or no. If the determination of step 610 is that the customer does not have a room that needs additional coverage, then operation proceeds from step 610 to return recommended placement of AP and/or extenders 650. However, if the determination of step 610 is that the customer does have a room that needs additional coverage, then operation proceeds from step 610 to step 616, in which server 226 locates the room that the customer indicated. Operation proceeds from step 616 to step 618 in which the server 618 recommends to move the router (AP) one or two adjacent rooms closer to the room that the customer indicated needed the additional coverage. Operation proceeds from step 618 to return recommended placement of AP and/or extenders 650.

Returning to step 612, in step 612, the server 226 determines if the customer has a room that needs additional coverage. In some embodiments, step 612 includes the server 226 sending an inquiry message, e.g., a pop-up message, to UE 218, to be presented to the customer requesting if the customer has a room that needs additional coverage and asking for information to identify or locate the room, and receiving a customer response from UE 218, and extracting the information from the customer response, e.g., yes with room information or no. If the determination of step 612 is that the customer does not have a room that needs additional coverage, then operation proceeds from step 612, via connecting node A 620 to step 628, in which the server 226 locates the room that has the worst RSSI average. However, if the determination of step 612 is that the customer does have a room that needs additional coverage, then operation proceeds from step 612, via connecting node B 622 to step 630, in which server 226 locates the room that the customer indicated. Operation proceeds from step 628 or step 630 to step 641.

Returning to step 614, in step 614, the server 226 determines if the customer has a room that needs additional coverage. In some embodiments, step 614 includes the server 226 sending an inquiry message, e.g., a pop-up message, to UE 218, to be presented to the customer requesting if the customer has a room that needs additional coverage and asking for information to identify or locate the room, and receiving a customer response from UE 218, and extracting the information from the customer response, e.g., yes with room information or no. If the determination of step 614 is that the customer does not have a room that needs additional coverage, then operation proceeds from step 614, via connecting node C 624 to step 632, in which the server 226 locates the two rooms that have the worst RSSI average. Operation proceeds from step 632 to step 641.

However, if the determination of step 614 is that the customer does have a room that needs additional coverage, then operation proceeds from step 614, via connecting node D 626 to step 634, in which server 226 determines how many rooms did the customer indicate. If the determination of step 634 is that the customer indicated one room, then operation proceeds from step 634 to step 636. However, if the determination of step 634 is that the customer has indicated two rooms, then operation proceeds from step 636 to step 640.

Returning to step 636, in step 636 server 226 locates the room that the customer indicated. Operation proceeds from step 636 to step 638. In step 638 server 638 locates the room that has the worst RSSI average that is not the room that the customer indicated. Operation proceeds from step 638 to step 641.

Returning to step 640, in step 640 the server 226 locates the two rooms that the customer indicated. Operation proceeds from step 640 to step 641.

In step 641 the server 226 recommends placement for one or two extenders, e.g., based on the determined number of extenders to be used. Step 642 includes step 641, which is executed once if the determined number of extenders to be used is one. Step 642 is executed twice if the determined number of extenders to be used is two.

In step 642 the server recommends to place an extender in a room that is between the router (AP) and an identified room (e.g., a room identified by the customer as needing additional coverage or a room identified by the server with worst RSSI). (Note: steps 628, 630, 632, 636, 638 and 640 are steps which identify (locate) rooms.) Operation proceeds from step 642 to step 644, in which the server communicates the recommendation from the server 226 to the UE 218 to be presented by the UE 218 to the customer. Operation proceeds from step 644 to step 646. In step 646, the server 226 receives a response to the recommendation from the UE 218 indicating acceptance or rejection of the recommendation. Operation proceeds from step 646 to step 648. In step 648, the server 226 determines if the customer accepted the proposed location(s). If the determination of step 648, is that the customer has not accepted the proposed locations, then operation proceeds from step 648 to step 640, in which the server 226 proposes an adjacent room to the last recommended room to the customer. Operation proceeds from step 650 to step 644, in which the server 644 communicates the new recommendation to the UE 218.

Returning to step 648, if the determination of step 648 is that the customer has accepted the proposed location(s), then operation proceeds, via connecting node E 652, to return recommended placement of AP and/or extenders 650.

FIG. 7 is a flowchart 700 of a number of extenders recommendation routine, in accordance with an exemplary embodiment. Operation starts in step 702 and proceeds to step 704. In step 704, the server 226 retrieves RSSI data from the RSSI database, e.g., the server 226 receives the stored collected set of RSSI data obtained from the guided or unguided survey, which was performed at the home site being evaluated. Operation proceeds from step 704 to step 705. In step 705, the server 226 processes the retrieved RSSI data and determines a median RSSI of the distribution of the set of data. Operation proceeds from step 705 to step 706.

In step 706 the server 226 determines, based on the median RSSI value of the distribution, how many extenders to recommend. In some embodiments, the determination of step 706 is further based on one or more predetermined thresholds, e.g., a first predetermined threshold, e.g., −60 dBm, and a second predetermined threshold, e.g., -70 dBm.

In step 707 the server 226 compares the median RSSI value to the first predetermined threshold, e.g., −60 dBm, and if the media RSSI value is determined to be greater than or equal to the first predetermined threshold, e.g. −60 dBm, then operation proceeds to step 708. In step 708 the server 226 classifies the ecosystem as a small ecosystem, and operation proceeds to step 714, in which the server 226 does not recommend adding extenders, e.g., the server 226 recommends 0 extenders. However, if the determination of step 707 is that the median RSSI value is not greater than or equal to the first threshold, e.g. −60 dBm, then operation proceeds from step 707 to step 709.

In step 709 the server 226, compares the median RSSI to the second predetermined threshold, e.g., −70 dBM, and determines if the median RSSI value is greater than or equal to the second predetermined threshold, e.g., −70 dBm. If the determination of step 709 is that the median RSSI value is greater than or equal to the second predetermined threshold, e.g., −70dBm, then operation proceeds to step 710, in which the server 226 determines that the median RSSI value is less than the first predetermined threshold, e.g., -60 dBm, and is greater than or equal to the second predetermined threshold, e.g., −70 dBm. Operation proceeds from step 710 to step 715, in which server 226 classifies the ecosystem as a medium ecosystem, and then operation proceeds to step 716, in which the server 226 determines 1 extender is recommended. However, if the determination of step 709 is that the median RSSI value is not greater than or equal to the second threshold, e.g. −70 dBm, then operation proceeds from step 709 to step 711.

In step 711, the server 226 determines that the median RSSI value is less than the second predetermined threshold, e.g., −70 dBm. Operation proceeds from step 711 to step 712, in which the server 226 classifies the ecosystem as a large ecosystem, and then operation proceeds to step 718, in which the server 226 determines 2 extenders are recommended.

Operation proceeds from step 706 to step 722. In step 722 the server 226 determines the extender type to recommend, e.g., based on the number of extenders being recommended. For example, the server recommends a first type of extender if one extender is recommended and recommends a second type of extender if multiple extenders are being recommended. Operation proceeds from step 722 to step 724. In step 724 the server 226 stores the extender recommendation, e.g., information indicating the determined number of recommended extenders and the determined extender type, in extender count and type database 230. Operation proceeds from step 724 to return step 726, e.g., a return to main routine and/or UE recommended number of extenders and recommended extender type.

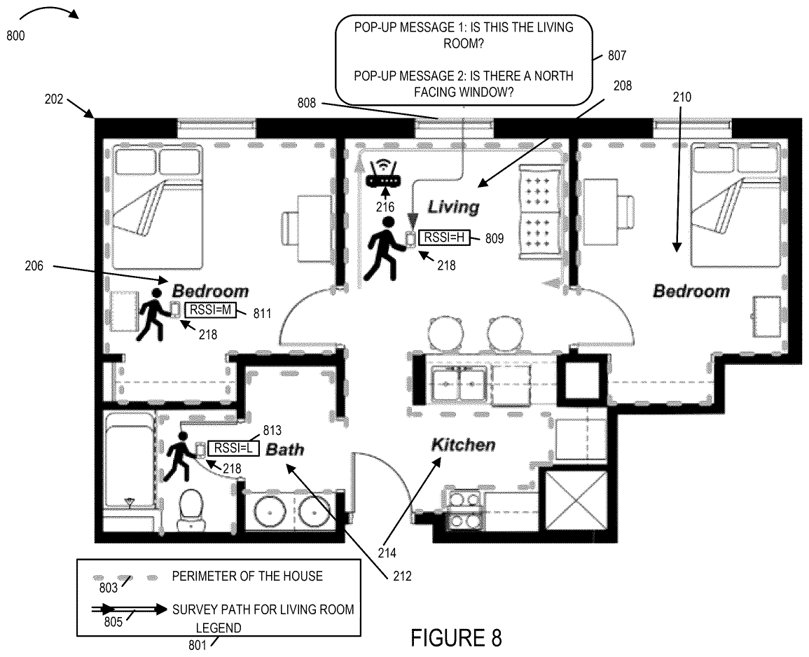

FIG. 8 is drawing 800, illustrating a guided approach to the collection of data. In the guided approach gathered metrics includes, e.g., room identifier information, floor/story information, dimension information, RSSI measurements, and geolocation information. Customer home site 202 is shown, which includes bedroom 1 206, living room 208, bedroom 2 210, bathroom 212, and kitchen 214. The AP 216 is located in living room 208 as shown. In the guided approach, in some embodiments, pop-up messages are communicated to the customer to direct the customer to move through the home site 202 and data is collected while the customer moves throughout the home site. Information block 807 illustrates exemplary pop-up messages sent to UE 218, which are displayed to the customer to direct the customer. The exemplary pop-up messages are part of an interaction between the customer and a server, which are used to locate, orient and direct the customer to follow a guided path around the home site 202. Exemplary pop-up message 1 is: “Is this the living room?”, is presented to the customer via the display of UE 218. Assuming the customer responds with an affirmation confirming that the customer is in the living room, a second pop-up message: “Is there a north facing window?” is sent to the customer, e.g., to locate and/or orient the customer within the room, e.g., an identify a starting point. In this example, the north facing window is living room window 808. Legend 801 indicates that large dashes 803 are used to indicate the perimeter of the rooms in the house. In some embodiments, in the guided approach to collect data, the customer is directed to follow a path along the perimeter of the rooms, e.g., being directed on a room by room basis, while UE 218 collects RSSI measurement data and corresponding location information as the customer with UE 218 moves along the path. Legend 810 further indicates arrow line 805 is used to indicate the directed (guided) survey path for the living room 208. The customer will be directed to follow similar guided survey paths for each of the other rooms (bedroom 2 210, kitchen 214, bath, 212 and bedroom 1 206).

Metrics including RSSI data and corresponding UE 218 location information, are gathered corresponding to different locations. Several exemplary RSSI measurements performed as part of the guided approach are shown for purposes of illustration; however, it should be appreciated that many measurements are actually performed as the customer moves along the directed path. Exemplary measurement value 809, which indicates high strength, is measured in living room 208. Exemplary RSSI measurement value 813, which indicates low strength, is measured in bathroom 212. Exemplary RSSI measurement value 811, which indicates medium strength, is measured in bedroom 1 206. In some embodiments when RSSI data is collected and analyzed, the ISP recommends an appropriate extender count based on the sample distribution. In some embodiments when RSSI data along with corresponding location data is collected and analyzed, the ISP recommends extender placement location(s) and/or AP placement location based on the analyzed collected data.

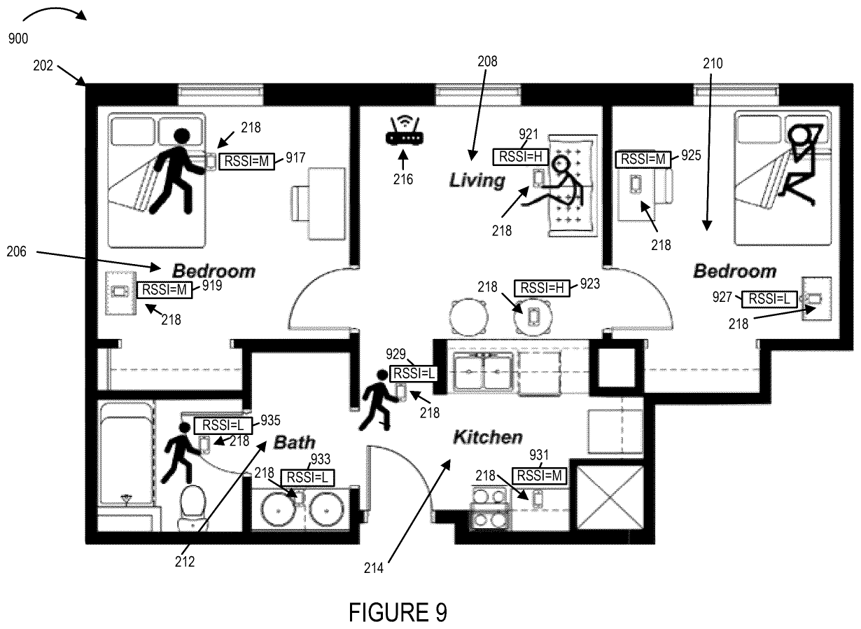

FIG. 9 is drawing 900, illustrating an unguided approach to the collection of data. Customer home site 202 is shown, which includes bedroom 1 206, living room 208, bedroom 2 210, bathroom 212, and kitchen 214. The AP 216 is located in living room 208 as shown. The customer UE 218, happens to be at different locations throughout the home 202, e.g., at different times of a day, e.g., as part of normal activity. Metrics including RSSI data and corresponding UE 218 location information, are gathered corresponding to different locations. RSSI measurement value 917, which indicates medium strength is measured at a first location in bedroom 1 206, and RSSI measurement value 919, which indicates medium strength is measured at a second location in bedroom 1 206. RSSI measurement value 921, which indicates high strength is measured at a first location in living room 208, and RSSI measurement value 923, which indicates high strength is measured at a second location in living room 208. RSSI measurement value 925, which indicates medium strength is measured at a first location in bedroom 2 210, and RSSI measurement value 927, which indicates low strength is measured at a second location in bedroom 2 210. RSSI measurement value 929, which indicates low strength is measured at a first location in kitchen 214, and RSSI measurement value 931, which indicates medium strength is measured at a second location in kitchen 214. RSSI measurement value 933, which indicates low strength is measured at a first location in bathroom 212, and RSSI measurement value 935, which indicates low strength is measured at a second location in bathroom 212. In some embodiments when RSSI data is collected and analyzed, the ISP recommends an appropriate extender count and/or recommended extender placement location(s) and/or AP placement location based on the sample distribution. In some embodiments when RSSI data along with corresponding location data is collected and analyzed, the ISP recommends extender placement location(s) and/or AP placement location based on the analyzed collected data.

The determination and collection of geolocation information will now be described. In some embodiments, a floorplan is uploaded, e.g., in the case where the customer already has a floorplan of his residence that he can upload to the app. Using the GPS of the mobile UE, the customer can geolocate his positioning on the layout, by first geolocating the outside perimeter of the layout and aligning GPS coordinates with reference points on the outside perimeter. GPS can be used on its own for geolocation, even if the customer can't upload a floorplan. Based on the building materials and the square footage of the residence GPS might not always be accurate. In that case, one or more indoor positioning systems (IPS) can be, and sometimes are, used. Exemplary indoor positioning systems (IPS), which may be, and sometimes are, used include: Cellular Triangulation and WiFi Triangulation. Cellular triangulation measures the time it takes for a signal (cellular signal) to travel from a phone (UE) to a cell tower and back and then calculates the distance based on the delay. Time measurements may be, and sometimes are, performed corresponding to each of plurality of cell towers. The phone's location is then estimated by using the known locations of the cell towers and the calculated distances. WiFi Triangulation, also known are WiFi fingerprinting or positioning, relies on using the measured strength and unique identifiers of received WiFi signals, transmitted from nearby WiFi access points, to determine a device's (UE's) location indoors. IPS systems can be used on their own or can be combined with GPS to achieve more accuracy.

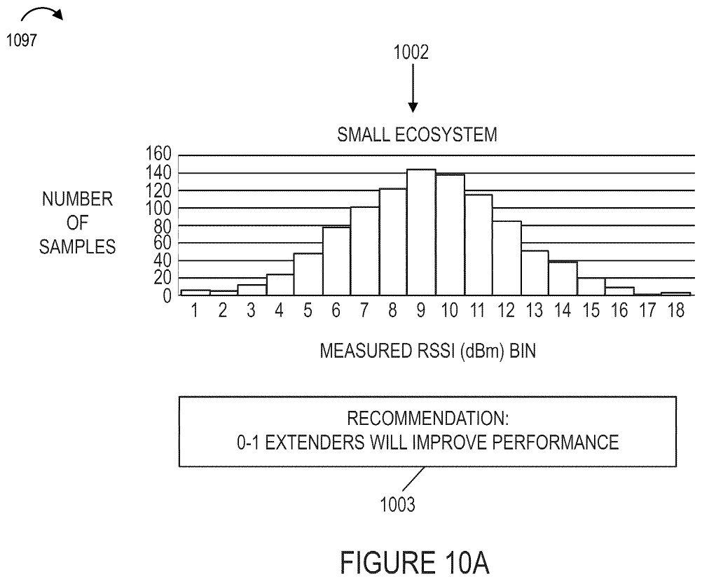

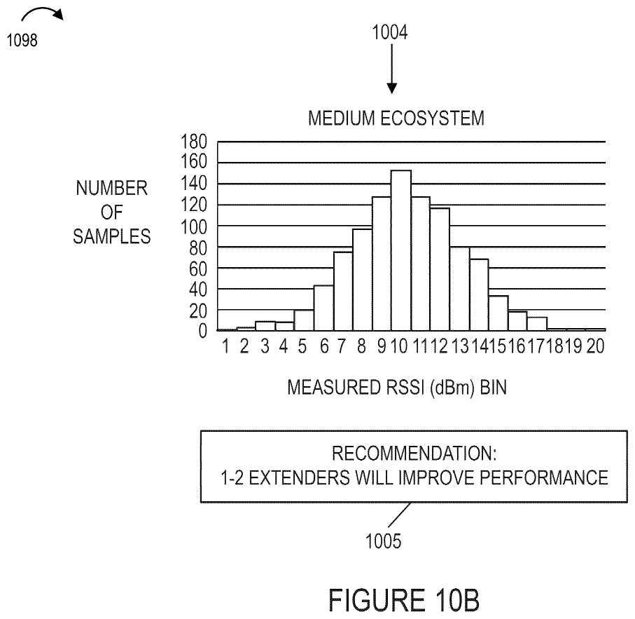

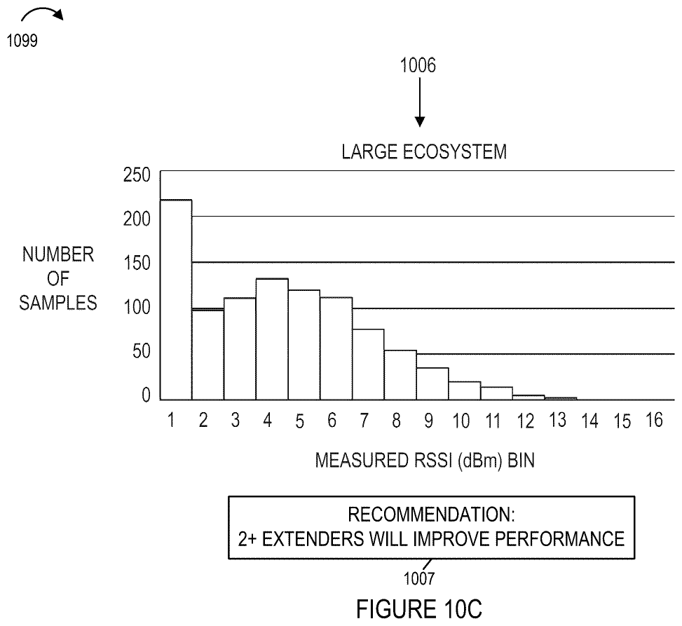

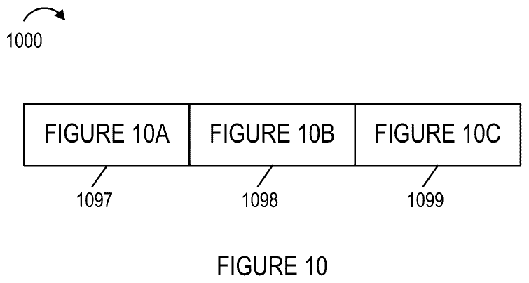

FIG. 10, comprising the combination of FIG. 10A, FIG. 10B and FIG. 10C, is a drawing 1000, which illustrates three exemplary sample distributions and corresponding recommendations as to the number of extenders. Drawing 1097 of FIG. 10A includes graph 1002 and corresponding recommendation 1003. Graph 1002 is a plot of number of samples vs measured RSSI (dBm) bin. Bin 1 corresponds to measured RSSI samples in the range of: [−126, −119] dBm. Bin 2 corresponds to measured RSSI samples in the range of: (−119, −111] dBm. Bin 3 corresponds to measured RSSI samples in the range of: (−111, −104] dBm. Bin 4 corresponds to measured RSSI samples in the range of: (−104, −97] dBm. Bin 5 corresponds to measured RSSI samples in the range of: (-97, −89] dBm. Bin 6 corresponds to measured RSSI samples in the range of: (−89, −82] dBm. Bin 7 corresponds to measured RSSI samples in the range of: (−82, −74] dBm. Bin 8 corresponds to measured RSSI samples in the range of: (−74, −67] dBm. Bin 9 corresponds to measured RSSI samples in the range of: (−67, −60] dBm. Bin 10 corresponds to measured RSSI samples in the range of: (−60, −52] dBm. Bin 11 corresponds to measured RSSI samples in the range of: (−52, −45] dBm. Bin 12 corresponds to measured RSSI samples in the range of: (−45, −37] dBm. Bin 13 corresponds to measured RSSI samples in the range of: (−37, −30] dBm. Bin 14 corresponds to measured RSSI samples in the range of: (−30, −23] dBm. Bin 15 corresponds to measured RSSI samples in the range of: (−23, −15] dBm. Bin 16 corresponds to measured RSSI samples in the range of: (−15, −8] dBm. Bin 17 corresponds to measured RSSI samples in the range of: (−8, 0] dBm. Bin 18 corresponds to measured RSSI samples in the range of: (0, 7] dBm. Graph 1002, when analyzed, results in a recommendation 1003 of 0-1 extenders to improve performance. The ecosystem of graph 1002 can be characterized as a small ecosystem.

Drawing 1098 of FIG. 10B includes graph 1004 and corresponding recommendation 1005. Graph 1004 is a plot of number of samples vs measured RSSI (dBm) bin. Bin 1 corresponds to measured RSSI samples in the range of: [−139, −132] dBm. Bin 2 corresponds to measured RSSI samples in the range of: (−132, −125] dBm. Bin 3 corresponds to measured RSSI samples in the range of: (−125, −118] dBm. Bin 4 corresponds to measured RSSI samples in the range of: (−118, −111] dBm. Bin 5 corresponds to measured RSSI samples in the range of: (−111, −104] dBm. Bin 6 corresponds to measured RSSI samples in the range of: (−104, −97] dBm. Bin 7 corresponds to measured RSSI samples in the range of: (−97, −89] dBm. Bin 8 corresponds to measured RSSI samples in the range of: (−89, −82] dBm. Bin 9 corresponds to measured RSSI samples in the range of: (−82, −75] dBm. Bin 10 corresponds to measured RSSI samples in the range of: (−75, −68] dBm. Bin 11 corresponds to measured RSSI samples in the range of: (−68, −61] dBm. Bin 12 corresponds to measured RSSI samples in the range of: (−61, −54] dBm. Bin 13 corresponds to measured RSSI samples in the range of: (−54, −47] dBm. Bin 14 corresponds to measured RSSI samples in the range of: (−47, −40] dBm. Bin 15 corresponds to measured RSSI samples in the range of: (−40, −33] dBm. Bin 16 corresponds to measured RSSI samples in the range of: (−33, −26] dBm. Bin 17 corresponds to measured RSSI samples in the range of: (−26, −18] dBm. Bin 18 corresponds to measured RSSI samples in the range of: (−18, −11] dBm. Bin 19 corresponds to measured RSSI samples in the range of: (−11, −4] dBm. Bin 20 corresponds to measured RSSI samples in the range of: (−4, 3] dBm. Graph 1004, when analyzed, results in a recommendation 1005 of 1-2 extenders to improve performance. The ecosystem of graph 1004 can be characterized as a medium ecosystem.

Drawing 1099 of FIG. 10C includes graph 1006 and corresponding recommendation 1007. Graph 1006 is a plot of number of samples vs measured RSSI (dBm) bin. Bin 1 corresponds to measured RSSI samples in the range of: [−100, −94] dBm. Bin 2 corresponds to measured RSSI samples in the range of: (−94, −88] dBm. Bin 3 corresponds to measured RSSI samples in the range of: (−88, −82] dBm. Bin 4 corresponds to measured RSSI samples in the range of: (−82, −76] dBm. Bin 5 corresponds to measured RSSI samples in the range of: (−76, −70] dBm. Bin 6 corresponds to measured RSSI samples in the range of: (−70, −64] dBm. Bin 7 corresponds to measured RSSI samples in the range of: (−64, −58] dBm. Bin 8 corresponds to measured RSSI samples in the range of :(−58, −52] dBm. Bin 9 corresponds to measured RSSI samples in the range of: (−52, −46] dBm. Bin 10 corresponds to measured RSSI samples in the range of: (−46, −40] dBm. Bin 11 corresponds to measured RSSI samples in the range of: (−40, −34] dBm. Bin 12 corresponds to measured RSSI samples in the range of: (−34, −28] dBm. Bin 13 corresponds to measured RSSI samples in the range of: (−28, −22] dBm. Bin 14 corresponds to measured RSSI samples in the range of: (−22, −16] dBm. Bin 15 corresponds to measured RSSI samples in the range of: (−16, −10] dBm. Bin 16 corresponds to measured RSSI samples in the range of: (−10, −4] dBm.

Graph 1006, when analyzed, results in a recommendation 1007 of 2+ extenders to improve performance. The ecosystem of graph 1006 can be characterized as a large ecosystem.

In some embodiments, the median RSSI value of the distribution is used to classify the ecosystem and recommend the number of extenders. In one such embodiment, i) if the median RSSI value of the distribution being analyzed is >−60 dBm, then the ecosystem is classified as a small ecosystem and 0 extenders are recommended; ii) if the median RSSI value of the distribution being analyzed is less than −60 dBm and greater than or equal to −70 dBm, then the ecosystem is classified as a medium ecosystem, and 1 extender is recommended; and iii) if the median RSSI value of the distribution being analyzed is less than −70 dBm, then the ecosystem is classified as a large ecosystem, and 2 extenders are recommended.

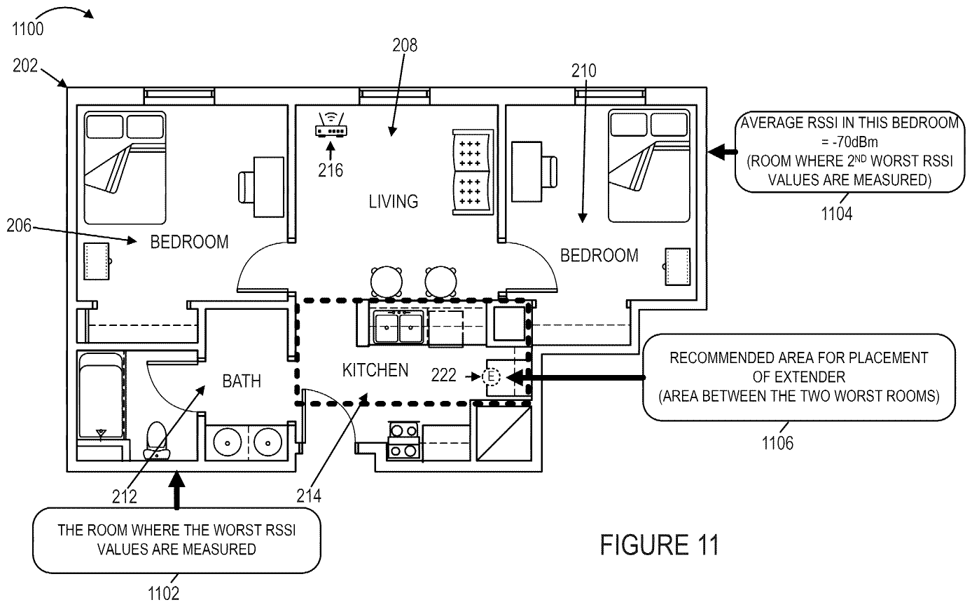

FIG. 11 is a drawing 1100, which illustrates an exemplary embodiment, in which the ISP recommends an extender placement based on: i) where in the layout the worst RSSI values were measured, and ii) the average measured RSSI in a room. In some embodiments, a server, e.g., customer support server 226, determines an average RSSI for each room, and ranks the rooms, e.g., from strongest to weakest average RSSI. Customer home site 202 is shown, which includes bedroom 1 206, living room 208, bedroom 2 210, bathroom 212, and kitchen 214. The AP 216 is located in living room 208 as shown. An average RSSI value for each of the rooms (206, 208, 210, 212, 214) is determined based on the collected RSSI measurements. In this case, there are two rooms, bathroom 212 and bedroom 2 210, that need better coverage. Bathroom 212 is the room where the worst RSSI values were measured, as indicated by information block 1102. The average RSSI in bedroom 2 210=−70 dBm, which makes bedroom 2 210, the room where the 2nd worst RSSI values were measured, as indicated by information block 1104. In this exemplary embodiment, the ISP will recommend the placement of an extender 222 within an area 1106 (represented by dashed rectangular box) between the worst two rooms (bathroom 210, bedroom 2 212). Area 1106 is a portion of kitchen 214. In some embodiments, the recommendation includes a precise best recommended location within region 1106, e.g., the position where extender (E) 222 is shown in FIG. 11.

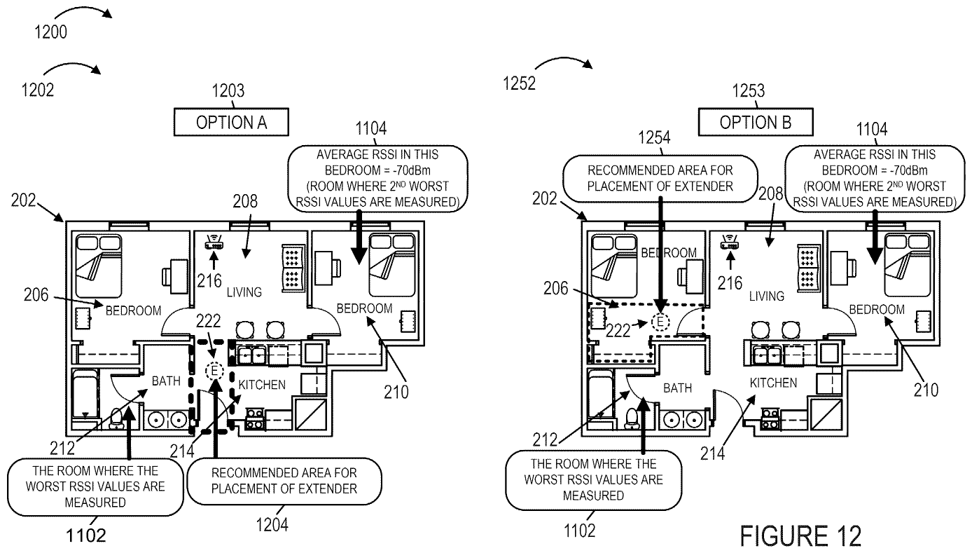

FIG. 12 is a drawing 1200, which illustrates an exemplary embodiment, in which the ISP recommends an extender placement based on: i) where in the layout the worst RSSI values were measured, ii) the average measured RSSI in a room, and iii) customer priority information. In this exemplary embodiment, the ISP will not make only one recommendation for the placement. If the customer is not happy with the first recommendation, the ISP will suggest other options until customer satisfaction is guaranteed. Drawing 1202 illustrates a first recommendation, Option A 1203. Drawing 1252 illustrates a second recommendation, Option B 1253.

Customer home site 202 is shown, which includes bedroom 1 206, living room 208, bedroom 2 210, bathroom 212, and kitchen 214. The AP 216 is located in living room 208 as shown. An average RSSI value for each of the rooms (206, 208, 210, 212, 214) is determined based on the collected RSSI measurements. In this case, the room where the worst RSSI values were measured is the bathroom 212, as indicated by information block 1102. The room where the 2nd worst RSSI values were measured is bedroom 2, as indicated by information block 1104.

If the customer's main priority is the coverage in the bathroom, and he is not interested in improving the coverage in other rooms, option A will be a recommendation for him. With option A, the recommended area for placement of an extender 222 is within area 1204 (as indicated by a dashed line rectangle). In some embodiments, the recommendation includes a precise best recommended location within region 1204, e.g., the position where extender (E) 222 is shown in drawing 1202 of FIG. 12.

If the customer's main priority is the coverage in the bathroom, but he does not want to or can not put the AP/extender in the kitchen or in the bathroom, option B will be a recommendation for him. With option B, the recommended area for placement of an extender 222 is within area 1254 (as indicated by a dashed line rectangle), which is a portion of bedroom 206 closest to the bathroom 212. In some embodiments, the recommendation includes a precise best recommended location within region 1254, e.g., the position where extender (E) 222 is shown in drawing 1252 of FIG. 12.

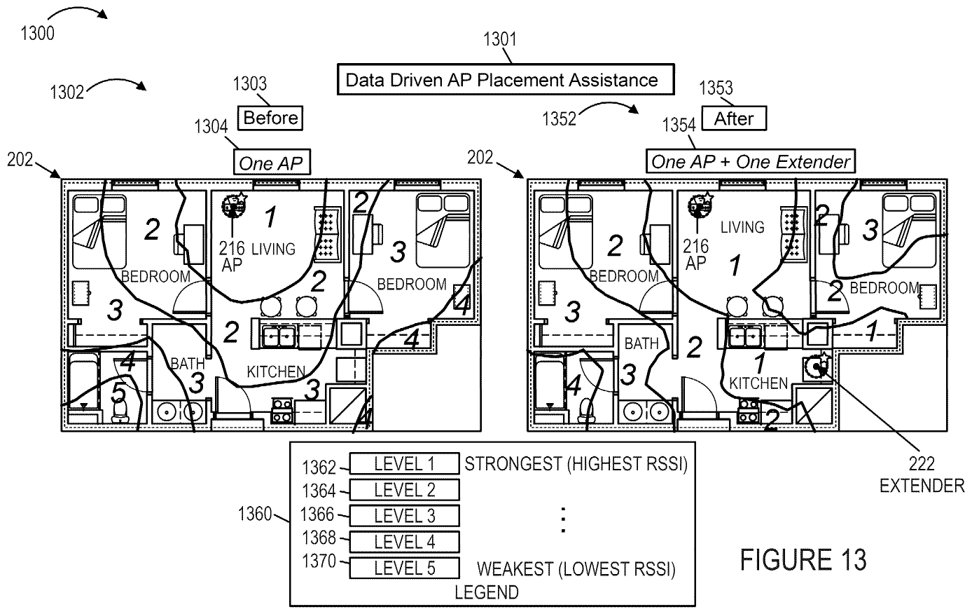

FIG. 13 is a drawing 1300 illustrating a visual representation of the extender benefit from the data driven AP/Extender Placement Assistance approach, as indicated in title box 1301. Drawing 1302 illustrates a before condition (1303) heat map for home site 202, for a one AP scenario 1304, in which AP 216 is installed and operating within home site 202. Drawing 1352 illustrates an after condition (1353) heat map for home site 202, for a one AP +one extender scenario 1354, in which AP 216 which was previously installed and operating within home site 202, has been supplemented to include recommended extender 222, which is now installed and operating.

FIG. 13 further includes legend 1360, which indicates that different level number designations (level designation “1” 1362, level designation “2” 1364, level designation “3” 1366, level designation “4” 1368, level designation “5” 1370) are used to indicate different levels of UE (measured or expected) RSSI signal strength, ranging from strongest (highest RSSI) to weakest (lowest RSSI). Based on the level designation numbering shown, using large bold level designation numbers and boundary lines in drawing 1302 and in drawing 1304,, drawing 1352 illustrates improved coverage, as compared to drawing 1302. In the before drawing 1302 (with only one AP), there is a level “5” area, which corresponds to the weakest measured signal strength (lowest RSSI); however, in after drawing 1352 (with one AP and one extender), there are now no level “5” areas, with the previously designated level “5” area now corresponding to level “3” and level “4” areas. In addition, the after drawing 1352 shows a significantly larger level “1” area, which corresponds to the strongest measured signal strength (highest RSSI), as compared to the before drawing 1302.

### Numbered List of Exemplary Method Embodiments

Method Embodiment 1. A method of facilitating wireless communications, the method comprising: operating a server (226), to receive (434 in case of unguided survey or 523 in case of guided survey) from a user equipment (UE) (218) corresponding to a customer which is located at a customer premises site (202) being surveyed, RSSI measurement information including RSSI measurements taken by the UE (218) over a period of time while the UE (218) is at the customer premises site (202); operating the server (226) to determine (706) a recommended number of wireless extenders based on the received RSSI information; and operating the server to communicate the recommended number of wireless extenders for the customer premises site to the UE device.

Method Embodiment 1a. The method of Method Embodiment 1, further comprising: operating the server (226) to determine an average RSSI value for each room; operating the server (226) to order the rooms based on determined average RSSI values (e.g., from the room having the worst (lowest) average RSSI to the room having the best (highest) average RSSI; and operating the server (226) to recommend to locate an extender in a room between the two rooms determined to have the lowest two average RSSI values.

Method Embodiment 1A. The method of Method Embodiment 1, wherein the recommended number of extenders is based on a median RSSI determined from the RSSI measurements taken by the UE while the UE was at the customer premises site (202).

Method Embodiment 2. The method of Method Embodiment 1, further comprising: operating the server (226) to make (722) an extender type recommendation based on the received RSSI measurement information based on the number of extenders being recommended.

Method Embodiment 2A. The method of Method Embodiment 2 wherein said step of making (722) an extender type recommendation includes recommending a first type extender (e.g., an extender which is intended to act as a single extender in the absence of other extenders) when a single wireless extender is recommended for the customer premises site and recommending a second type extender (e.g., a network extender capable of smart antenna array configuration and/or configuration taking into consideration the presence of one or more other extenders at the same site) when multiple wireless extenders are recommended for the customer premises site.

Method Embodiment 2B. The method Method Embodiment 1, further comprising: operating the server (226) to make an extender type recommendation based one or more of: i) the type of router including an AP or the type of AP currently installed at the customer premises site (e.g., ensure compatibility), ii) the communications bands being used at the customer premises site (e.g., model that supports same bands as the currently installed AP), iii) the distance to be extended (e.g., select appropriate model (with transmit power level) to meets range requirements), or iv) the number of directions in which the extender is to extend coverage (e.g., is a smart antenna array needed or is omni-direction antenna sufficient).

Method Embodiment 3. The method of Method Embodiment 1, wherein the RSSI measurement information received from the UE includes for each RSSI measurement value location information indicating the location at which the RSSI measurement was taken.

Method Embodiment 3A. The method of Method Embodiment 3, wherein said location information is a room identifier or geolocation information (e.g., GPS coordinates).

Method Embodiment 3B. The method of Method Embodiment 3A, wherein said geolocation information is obtained from one or more of: i) UE received GPS signals, ii) internal UE IMU (inertial measurement unit) measurements aiding a last (e.g., outdoor) GPS position fix, ii) cellular triangulation (e.g., based on time measurement of cellular signals from UE to one or more cell towers and back to UE, and known locations of the cell towers), or iii) WiFi triangulation (e.g., sometimes referred to as WiFi fingerprinting or positioning, e.g., using one or more nearby WiFi APs at known locations).

Method Embodiment 4. The method of Method Embodiment 1, further comprising: operating the server to provide (318) the user of the UE (218) an opportunity to select between performing a guided survey or an unguided site survey.

Method Embodiment 5. The method of Method Embodiment 4, further comprising: operating the server to instruct (416 or 418) the UE to collect RSSI measurements (e.g., a first or second predetermined number of RSSI measurements depending on the survey accuracy level requested by the user) corresponding to the customer premises, in response to determining (N path of step 328) that the user selected that an unguided site survey be performed; and wherein the received RSSI measurement information includes RSSI measurements collected by the UE during normal unguided use at the customer premises over a period of time in which the RSSI measurements are made.

Method Embodiment 5A. The method of Method Embodiment 5, wherein the server instructs the UE to record location information with each recorded RSSI measurement collected by the UE.

Method Embodiment 6. The method of Method Embodiment 5, further comprising: operating the server to provide (404) the user of the UE if they want a quick site survey or prefer a longer more accurate survey; and operating the server to indicate (as part of step 416 or 418) the number of RSSI measurements to be collected when instructing the UE to collect RSSI measurements, said server indicating a first number of RSSI measurements when the user selects a quick site survey and indicating a second larger number of RSSI measurements when the user selects the longer more accurate site survey.

Method Embodiment 7. The method of Method Embodiment 4, further comprising: operating the server (226) to receive (512, 514) survey starting location information; operating the server (226) to instruct (516) the user to walk around the perimeter of a room at the site being surveyed or the perimeter of the site being surveyed; and wherein the received RSSI information includes RSSI measurements collected while the user moves around the site in accordance with the communicated instructions.

Method Embodiment 8. The method of Method Embodiment 7 wherein the received survey starting location information (see step 512) includes a room identifier (e.g., room name) and room location information (story or floor of site on which the room at which the survey is starting is located).

Method Embodiment 9. The method of Method Embodiment 7, further comprising: prior to receiving said survey starting location information, receiving (504) from the UE a user provided floorplan of the site to be surveyed; and wherein the received survey starting location information includes an indication of a room on the floorplan or starting location within a room on the floorplan.

Method Embodiment 10. The method of Method Embodiment 1, further comprising: operating the server to recommend (618) moving an access point (AP) when the recommended number of wireless extenders is zero (adding a wireless extender is not recommended) and the customer has a room that needs additional wireless coverage (e.g., as indicated by user input provided to the server).

Method Embodiment 11. The method of Method Embodiment 10, wherein recommending (618) moving the access point includes recommending moving the access point at least one room closer to the room the customer indicated needs additional coverage.

Method Embodiment 12. The method of Method Embodiment 1, the method further comprising: operating the server (226) to recommend (642) wireless extender placement.

Method Embodiment 13. The method of Method Embodiment 12, wherein recommending (642) wireless extender placement includes recommending placement of a wireless extender to be added to the customer premises site to a room located between an access point (AP) at the customer premises site and a room that has the worst average RSSI at the customer premises.

Method Embodiment 13A. The method of Method Embodiment 12, wherein recommending (642) wireless extender placement includes recommending placement of a wireless extender to be added to the customer premises site to a room located between a room that has the worst average RSSI at the customer premises and a room that has the second worst average RSSI value at the customer pre mises.

Method Embodiment 14. The method of Method Embodiment 12,wherein recommending (642) wireless extender placement includes recommending placement of a wireless extender to be added to the customer premises site to a room located between an access point (AP) at the customer premises site and a room identified by the user of the UE as needing additional wireless coverage.

### Numbered List of Exemplary Apparatus Embodiments

Apparatus Embodiment 1. A customer support server (226) for providing support to a customer using a wireless access point (AP), the server (226) comprising: an interface (234) for receiving and sending information and messages; a memory (236); and a processor (232) coupled to said interface (234) and memory (236) by a bus (235), the processor (232) being configured to control the customer support server (226) to: receive (434 in case of unguided survey or 523 in case of guided survey) from a user equipment (UE) (218) corresponding to a customer which is located at a customer premises site (202) being surveyed, RSSI measurement information including RSSI measurements taken by the UE (218) over a period of time while the UE (218) is at the customer premises site (202); determine (706) a recommended number of wireless extenders based on the received RSSI information; and communicate the recommended number of wireless extenders for the customer premises site to the UE device.

Apparatus Embodiment 1a. The customer support server (226) of Apparatus Embodiment 1, wherein said processor (232) is further configured to control the customer support server (226) to: determine an average RSSI value for each room; order the rooms based on determined average RSSI values (e.g., from the room having the worst (lowest) average RSSI to the room having the best (highest) average RSSI; and recommend to locate an extender in a room between the two rooms determined to have the lowest two average RSSI values.

Apparatus Embodiment 1A. The customer support server (226) of Apparatus Embodiment 1, wherein the recommended number of extenders is based on a median RSSI determined from the RSSI measurements taken by the UE while the UE was at the customer premises site (202).

Apparatus Embodiment 2. The customer support server (226) of Apparatus Embodiment 1, wherein said processor (232) is further configured to control the customer support server (226) to: make (722) an extender type recommendation based on the received RSSI measurement information based on the number of extenders being recommended.

Apparatus Embodiment 2A. The customer support server (226) of Apparatus Embodiment 2, wherein said processor (232) is further configured to control the customer support server (226) to: recommend a first type extender (e.g., an extender which is intended to act as a single extender in the absence of other extenders) when a single wireless extender is recommended for the customer premises site and recommend a second type extender (e.g., a network extender capable of smart antenna array configuration and/or configuration taking into consideration the presence of one or more other extenders at the same site) when multiple wireless extenders are recommended for the customer premises site, as part of being configured to control the customer support server to make (722) an extender type recommendation.

Apparatus Embodiment 2B. The customer support server (226) of Apparatus Embodiment 1, wherein said processor (232) is further configured to control the customer support server (226) to: make an extender type recommendation based one or more of: i) the type of router including an AP or the type of AP currently installed at the customer premises site (e.g., ensure compatibility), ii) the communications bands being used at the customer premises site (e.g., model that supports same bands as the currently installed AP), iii) the distance to be extended (e.g., select appropriate model (with transmit power level) to meets range requirements), or iv) the number of directions in which the extender is to extend coverage (e.g., is a smart antenna array needed or is omni-direction antenna sufficient).

Apparatus Embodiment 3. The customer support server (226) of Apparatus Embodiment 1, wherein the RSSI measurement information received from the UE includes for each RSSI measurement value location information indicating the location at which the RSSI measurement was taken.

Apparatus Embodiment 3A. The customer support server (226) of Apparatus Embodiment 3, wherein said location information is a room identifier or geolocation information (e.g., GPS coordinates).

Apparatus Embodiment 3B. The customer support server (226) of Apparatus Embodiment 3A, wherein said geolocation information is obtained from one or more of: i) UE received GPS signals, ii) internal UE IMU (inertial measurement unit) measurements aiding a last (e.g., outdoor) GPS position fix, ii) cellular triangulation (e.g., based on time measurement of cellular signals from UE to one or more cell towers and back to UE, and known locations of the cell towers), or iii) WiFi triangulation (e.g., sometimes referred to as WiFi fingerprinting or positioning, e.g., using one or more nearby WiFi APs at known locations).

Apparatus Embodiment 4. The customer support server (226) of Apparatus Embodiment 1, wherein said processor (232) is further configured to control the customer support server (226) to: provide (318) the user of the UE (218) an opportunity to select between performing a guided survey or an unguided site survey.

Apparatus Embodiment 5. The customer support server (226) of Apparatus Embodiment 4, wherein said processor (232) is further configured to control the customer support server (226) to: instruct (416 or 418) the UE to collect RSSI measurements (e.g., a first or second predetermined number of RSSI measurements depending on the survey accuracy level requested by the user) corresponding to the customer premises, in response to determining (N path of step 328) that the user selected that an unguided site survey be performed; and wherein the received RSSI measurement information includes RSSI measurements collected by the UE during normal unguided use at the customer premises over a period of time in which the RSSI measurements are made.

Apparatus Embodiment 5A. The customer support server (226) of Apparatus Embodiment 5, wherein said processor (232) is further configured to control the customer support server (226) to: instruct the UE to record location information with each recorded RSSI measurement collected by the UE.

Apparatus Embodiment 6. The customer support server (226) of Apparatus Embodiment 5, wherein said processor (232) is further configured to control the customer support server (226) to: provide (404) the user of the UE if they want a quick site survey or prefer a longer more accurate survey; and indicate (as part of step 416 or 418) the number of RSSI measurements to be collected when instructing the UE to collect RSSI measurements, said server indicating a first number of RSSI measurements when the user selects a quick site survey and indicating a second larger number of RSSI measurements when the user selects the longer more accurate site survey.

Apparatus Embodiment 7. The customer support server (226) of Apparatus Embodiment 4, wherein said processor (232) is further configured to control the customer support server (226) to: receive (512, 514) survey starting location information; instruct (516) the user to walk around the perimeter of a room at the site being surveyed or the perimeter of the site being surveyed; and wherein the received RSSI information includes RSSI measurements collected while the user moves around the site in accordance with the communicated instructions.

Apparatus Embodiment 8. The customer support server (226) of Apparatus Embodiment 7 wherein the received survey starting location information (see step 512) includes a room identifier (e.g., room name) and room location information (story or floor of site on which the room at which the survey is starting is located).

Apparatus Embodiment 9. The customer support server (226) of Apparatus Embodiment 7, wherein said processor (232) is further configured to control the customer support server (226) to: prior to receiving said survey starting location information, receive (504) from the UE a user provided floorplan of the site to be surveyed; and wherein the received survey starting location information includes an indication of a room on the floorplan or starting location within a room on the floorplan.

Apparatus Embodiment 10. The customer support server (226) of Apparatus Embodiment 1, wherein said processor (232) is further configured to control the customer support server (226) to: recommend (618) moving an access point (AP) when the recommended number of wireless extenders is zero (adding a wireless extender is not recommended) and the customer has a room that needs additional wireless coverage (e.g., as indicated by user input provided to the server).

Apparatus Embodiment 11. The customer support server (226) of Apparatus Embodiment 10, wherein said processor (232) is further configured to control the customer support server (226) to: recommend moving the access point at least one room closer to the room the customer indicated needs additional coverage, as part of being configured to control the customer support server to recommend (618) moving the access point.

Apparatus Embodiment 12. The customer support server (226) of Apparatus Embodiment 1, wherein said processor (232) is further configured to control the customer support server (226) to: recommend (642) wireless extender placement.

Apparatus Embodiment 13. The customer support server (226) of Apparatus Embodiment 12, wherein said processor (232) is configured to control the customer support server (226) to: recommend placement of a wireless extender to be added to the customer premises site to a room located between an access point (AP) at the customer premises site and a room that has the worst average RSSI at the customer premises, as part of being configured to control the customer support server to recommend (642) wireless extender placement.

Apparatus Embodiment 13A. The customer support server (226) of Apparatus Embodiment 12, wherein said processor (232) is configured to control the customer support server (226) to: recommend placement of a wireless extender to be added to the customer premises site to a room located between a room that has the worst average RSSI at the customer premises and a room that has the second worst average RSSI value at the customer premises, as part of being configured to control the customer support server to recommend (642) wireless extender placement.

Apparatus Embodiment 14. The customer support server (226) of Apparatus Embodiment 12, wherein said processor (232) is configured to control the customer support server (226) to: recommend placement of a wireless extender to be added to the customer premises site to a room located between an access point (AP) at the customer premises site and a room identified by the user of the UE as needing additional wireless coverage, as part of being configured to control the customer support server to recommend (642) wireless extender placement.

### Numbered List of Exemplary Non-Transitory

### Computer Readable Medium Embodiments

Non-Transitory Computer Readable Medium Embodiment 1. A non-transitory computer readable medium including machine executable instructions, which when executed by a processor (232) of a server (226), control the server (226) to perform the steps of: operating the server (226), to receive (434 in case of unguided survey or 523 in case of guided survey) from a user equipment (UE) (218) corresponding to a customer which is located at a customer premises site (202) being surveyed, RSSI measurement information including RSSI measurements taken by the UE (218) over a period of time while the UE (218) is at the customer premises site (202); operating the server (226) to determine (706) a recommended number of wireless extenders based on the received RSSI information; and operating the server to communicate the recommended number of wireless extenders for the customer premises site to the UE device.

The techniques of various embodiments may be implemented using software, hardware and/or a combination of software and hardware. Various embodiments are directed to apparatus, e.g., servers such as customer support servers and/or test servers, wireless extenders such as WiFi extenders, access points (APs) such as WiFi APs, base stations such as 5G cellular base stations, mobile handsets, user equipment (UE) devices such as UEs supporting WiFi and cellular communications, IP edge devices, servers, network nodes, and/or network equipment devices. Various embodiments are also directed to methods, e.g., method of controlling and/or operating servers, wireless extenders, access points, base stations, mobile handsets, UE devices, IP edge devices, servers, network nodes, etc. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order and are not meant to be limited to the specific order or hierarchy presented. In some embodiments, one or more processors are used to carry out one or more steps of each of the described methods.

In various embodiments each of the steps or elements of a method are implemented using one or more processors. In some embodiments, each of elements or steps are implemented using hardware circuitry.

In various embodiments devices, servers, nodes and/or elements described herein are implemented using one or more components to perform the steps corresponding to one or more methods, for example, message reception, signal processing, sending, comparing, determining and/or transmission steps. Thus, in some embodiments various features are implemented using components or, in some embodiments, logic, such as, for example, logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, e.g., communications nodes such as a customer support server, a test server, a wireless extender, an access point, base station, mobile handset device, a UE, are configured to perform the steps of the methods described as being performed by the customer support server, test server, wireless extender, access point, base station, mobile handset device, UE. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e.g., the customer support server, the test server, wireless extender, access point, base station, mobile handset device, UE with a processor which includes a component corresponding to each of the steps of the various described methods performed by the device in which the processor is included. In some but not all embodiments a device, e.g., the customer support server, test server, wireless extender, access point, base station, mobile handset device, UE, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g. one or more steps described above. Depending on the embodiment, the computer program product can, and sometimes does, include different code for each step to be performed. Thus, the computer program product may, and sometimes does, include code for each individual step of a method, e.g., a method of controlling a customer support server, a test server, wireless extender, access point, base station, mobile handset device, UE. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device such as a customer support serve, a test server, a wireless extender, an access point, a base station, a mobile handset device, a UE, or other device described in the present application.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A method of facilitating wireless communications, the method comprising:
operating a server, to receive from a user equipment (UE) corresponding to a customer which is located at a customer premises site being surveyed, RSSI measurement information including RSSI measurements taken by the UE over a period of time while the UE is at the customer premises site;
operating the server to determine a recommended number of wireless extenders based on the received RSSI information; and
operating the server to communicate the recommended number of wireless extenders for the customer premises site to the UE device.

2. The method of claim 1, further comprising:
operating the server to make an extender type recommendation based on the received RSSI measurement information based on the number of extenders being recommended.

3. The method of claim 1, wherein the RSSI measurement information received from the UE includes for each RSSI measurement value location information indicating the location at which the RSSI measurement was taken.

4. The method of claim 1, further comprising:
operating the server to provide the user of the UE an opportunity to select between performing a guided survey or an unguided site survey.

5. The method of claim 4, further comprising:
operating the server to instruct the UE to collect RSSI measurements corresponding to the customer premises, in response to determining that the user selected that an unguided site survey be performed; and
wherein the received RSSI measurement information includes RSSI measurements collected by the UE during normal unguided use at the customer premises over a period of time in which the RSSI measurements are made.

6. The method of claim 5, further comprising:
operating the server to provide the user of the UE if they want a quick site survey or prefer a longer more accurate survey; and
operating the server to indicate the number of RSSI measurements to be collected when instructing the UE to collect RSSI measurements, said server indicating a first number of RSSI measurements when the user selects a quick site survey and indicating a second larger number of RSSI measurements when the user selects the longer more accurate site survey.

7. The method of claim 4, further comprising:
operating the server to receive survey starting location information;
operating the server to instruct the user to walk around the perimeter of a room at the site being surveyed or the perimeter of the site being surveyed;
and wherein the received RSSI information includes RSSI measurements collected while the user moves around the site in accordance with the communicated instructions.

8. The method of claim 7 wherein the received survey starting location information includes a room identifier and room location information.

9. The method of claim 7, further comprising:
prior to receiving said survey starting location information, receiving from the UE a user provided floorplan of the site to be surveyed; and
wherein the received survey starting location information includes an indication of a room on the floorplan or starting location within a room on the floorplan.

10. The method of claim 1, further comprising:
operating the server to recommend moving an access point (AP) when the recommended number of wireless extenders is zero and the customer has a room that needs additional wireless coverage.

11. The method of claim 10, wherein recommending moving the access point includes recommending moving the access point at least one room closer to the room the customer indicated needs additional coverage.

12. The method of claim 1, the method further comprising:
operating the server to recommend wireless extender placement.

13. The method of claim 12, wherein recommending wireless extender placement includes recommending placement of a wireless extender to be added to the customer premises site to a room located between an access point (AP) at the customer premises site and a room that has the worst average RSSI at the customer premises.

14. A customer support server for providing support to a customer using a wireless access point (AP), the server comprising:
an interface for receiving and sending information and messages;
a memory;
and a processor coupled to said interface and memory by a bus, the processor being configured to control the customer support server to:
receive from a user equipment (UE) corresponding to a customer which is located at a customer premises site being surveyed, RSSI measurement information including RSSI measurements taken by the UE over a period of time while the UE is at the customer premises site;
determine a recommended number of wireless extenders based on the received RSSI information; and
communicate the recommended number of wireless extenders for the customer premises site to the UE device.

15. The customer support server of claim 14, wherein said processor is further configured to control the customer support server to:
make an extender type recommendation based on the received RSSI measurement information based on the number of extenders being recommended.

16. The customer support server of claim 14, wherein the RSSI measurement information received from the UE includes for each RSSI measurement value location information indicating the location at which the RSSI measurement was taken.

17. The customer support server of claim 14, wherein said processor is further configured to control the customer support server to:
provide the user of the UE an opportunity to select between performing a guided survey or an unguided site survey.

18. The customer support server of claim 17, wherein said processor is further configured to control the customer support server to:
instruct the UE to collect RSSI measurements corresponding to the customer premises, in response to determining that the user selected that an unguided site survey be performed; and
wherein the received RSSI measurement information includes RSSI measurements collected by the UE during normal unguided use at the customer premises over a period of time in which the RSSI measurements are made.

19. The customer support server of claim 18, wherein said processor is further configured to control the customer support server to:
provide the user of the UE if they want a quick site survey or prefer a longer more accurate survey; and
indicate the number of RSSI measurements to be collected when instructing the UE to collect RSSI measurements, said server indicating a first number of RSSI measurements when the user selects a quick site survey and indicating a second larger number of RSSI measurements when the user selects the longer more accurate site survey.

20. A non-transitory computer readable medium including machine executable instructions, which when executed by a processor of a server, control the server to perform the steps of:
operating the server, to receive from a user equipment (UE) corresponding to a customer which is located at a customer premises site being surveyed, RSSI measurement information including RSSI measurements taken by the UE over a period of time while the UE is at the customer premises site;
operating the server to determine a recommended number of wireless extenders based on the received RSSI information; and
operating the server to communicate the recommended number of wireless extenders for the customer premises site to the UE device.
